(19) United States
(12) Patent Application Publication
(10) Pub. No.: US 2026/0350002 A1
(43) Pub. Date: Nov. 5, 2026

(54) Voice-Based Dynamic Real Estate Contract Completion System

(71) Applicant: Market Impact Media, LLC, Beavercreek, OH (US)

(72) Inventor: Tyler Morton, Beavercreek, OH (US)

(21) Appl. No.: 19/660,070

(22) Filed: Apr. 27, 2026

Related U.S. Application Data
(60) Provisional application No. 63/795,244, filed on Apr. 26, 2025.

(51) Int. Cl. G06F 16/2453; G06Q 50/163

(52) U.S. Cl. CPC G06F 16/24534; G06Q 50/163

(57) ABSTRACT

A voice-based system and method for transforming unstructured natural language into structured real estate transaction data. The system utilizes a multi-layered architecture comprising a transcription service, a conversational contract engine, and a platform-agnostic integration layer. A dynamic questionnaire engine adaptively sequences inquiries based on transaction-type context and previously collected data, utilizing bifurcated name-origin logic to minimize user friction. The system features a semantic field extraction engine that parses compound utterances into discrete data points, including normalized geographic components and relative temporal expressions converted into exact calendar dates. To ensure transactional integrity, an iterative error recovery module identifies downstream validation failures, programmatically prunes non-compliant fields, and resubmits valid data payloads. In some embodiments, a weighted, multi-signal scoring model evaluates deterministic and AI-derived semantic signals to proactively generate transaction drafts. The invention effectively bridges informal speech with the rigid requirements of diverse contract management platforms.

### CROSS-REFERENCE TO RELATED APPLICATION

This patent application claims priority to U.S. Provisional Patent Application No. 63/795,244, filed on Apr. 26, 2025, and entitled “Voice-Based Dynamic Real Estate Contract Completion System.” The disclosure of the prior Application is considered part of and is incorporated by reference into this patent application.

### BACKGROUND

The present invention relates generally to real estate transaction management and, more particularly, to a platform-agnostic, voice-based system that utilizes dynamic conversational logic to transform natural language into structured contract data.

Traditional real estate contract creation is a manual, labor-intensive process that requires practitioners to navigate complex, static web forms within specific transaction management platforms. Current speech-enabled systems in this domain suffer from several technical limitations. Existing dictation systems typically require field-by-field voice input, failing to parse compound natural language statements into multiple structured fields simultaneously. Prior art platforms utilize static questionnaires that ask for all participant information regardless of the transaction type (e.g., asking for seller info during a purchase offer), creating unnecessary workflow friction. Conventional systems often require exact date formats (MM/DD/YYYY) and standardized geographic codes, lacking the ability to convert relative temporal expressions like “close in three weeks” into precise calendar dates. Most systems fail entirely when a downstream API rejects a data payload due to minor validation errors or template variations, requiring manual user intervention to identify and correct the offending field. There exists a need for a system that intelligently adapts its data collection based on the specific transaction context while providing a resilient bridge between informal human speech and the structured requirements of diverse contract management platforms.

### SUMMARY

The present invention provides a voice-based dynamic real estate contract completion system configured to transform unstructured natural language into structured, platform-independent transaction data. The system may comprise a multi-layered architecture—including a Client Layer, a Processing Layer, and a Contract Platform Integration Layer—designed to bridge the gap between informal human speech and the rigid schema requirements of third-party contract management platforms.

The Client Layer may capture compound natural language statements through a voice interface and transmits encoded audio via a Universal Communication Gateway. The Processing Layer may utilize a Transcription Service to convert audio into a dynamic transcription data stream using memory-efficient chunked decoding. A Conversational Contract Engine may subsequently transform this transcript into a domain-specific ContractDraft state object. This engine may implement an Intent Classifier for transaction type auto-detection and a Semantic Field Extraction engine that employs specialized algorithmic logic units—including address, name, financial, and relative date parsers—to decompose single utterances into a plurality of structured data points simultaneously.

The system may incorporate a Dynamic Questionnaire Engine, which functions as a state-machine-driven controller to determine the next logical inquiry based on a hierarchical priority evaluation. The engine may utilize a “bifurcated name-origin logic” to distinguish between auto-extracted data and direct user responses, ensuring high data integrity through a Priority 1 confirmation workflow while minimizing conversational friction. Additionally, the engine may implement auto-suggestive field mutations, such as predicting an earnest money holder based on the extraction of a financial amount.

To ensure robust interoperability, the Contract Platform Integration Layer may utilize a three-stage abstraction process (Workspace Creation, Field Population, and Participant Assignment). This layer incorporates an Iterative Error Recovery sequence that performs graceful degradation by programmatically pruning invalid fields from a rejected payload and resubmitting valid data. The system further includes a platform authentication flow with an automated retry-on-expiry mechanism to manage the lifecycle of secure credentials transparently.

In some embodiments, the system incorporates an Intent Inference and Proactive Draft Generation Architecture. This embodiment utilizes a weighted, multi-signal scoring model that evaluates deterministic transactional signals and AI-derived semantic signals (e.g., commitment posture and trajectory stability) across a rolling conversation window. When an aggregate intent score exceeds a context-aware execution threshold and satisfies mandatory gating conditions, the system proactively generates a staged transaction draft and an explanation snapshot without an explicit user command. A human-in-the-loop validation layer allows agents to approve or reject these proactive actions, providing structured feedback that the system uses to recalibrate signal weights and threshold values in a closed-loop refinement cycle.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a high-level block diagram of an embodiment illustrating the multi-layered architecture of the system, including the Client Layer, Processing Layer, Persistence Layer, and External Services.

FIG. 2A is a schematic view of the Semantic Field Extraction Engine's parsing pipeline of an embodiment, detailing the specific logic and patterns for the Address Parser, Name Parser, Price Parser, and Earnest Money Parser.

FIG. 2B illustrates the Relative Date Parser logic and an exemplary structured output object containing the aggregated data from the parsing pipeline.

FIG. 3A is a flowchart depicting the first three stages of an embodiment of the Dynamic Questionnaire Engine's priority evaluation order, focusing on Pending Confirmations, Participant Collection, and Address Completeness.

FIG. 3B is a continuation of the Dynamic Questionnaire Engine flowchart, illustrating Priority 4 for Financial Details, Priority 5 for Timeline Details, and the final completion state.

FIG. 4 is a detailed view of an embodiment of the Name Confirmation Workflow, contrasting Scenario A (names extracted from initial voice input) with Scenario B (names provided as a direct response).

FIG. 5 is a diagram illustrating an embodiment of the Earnest Money Collection Flow and the logic for auto-suggesting contextual defaults for the earnest money holder.

FIG. 6A is the first part of an embodiment of a sequence diagram for Iterative Error Recovery, showing an initial request, a platform validation error, and the subsequent parsing of that error response.

FIG. 6B is the second part of an embodiment of the Iterative Error Recovery sequence, illustrating the pruned retry request and the successful platform response.

FIG. 7 is a flowchart illustrating an embodiment of the Platform Authentication Flow and the ‘fetchWithAutoRefresh( )’ logic for managing expired access tokens.

FIG. 8A is a block diagram of an embodiment the first two layers of the Proactive Draft Generation Architecture: Conversation Capture and Signal Extraction.

FIG. 8B illustrates an embodiment of the Proposal Resolution Layer and the mathematical components of the Intent Scoring Engine.

FIG. 8C is a flowchart detailing an embodiment of the final stages of the proactive architecture, including Gating, Proactive Draft Generation, Agent Validation, and the Feedback and Model Refinement Loop.

These illustrations are provided to assist in the understanding of the exemplary embodiments as described in more detail below and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION

The following describes examples with respect to the real estate industry, but the principles, methods and designs described may be applicable, in whole or in part, to many other industries.

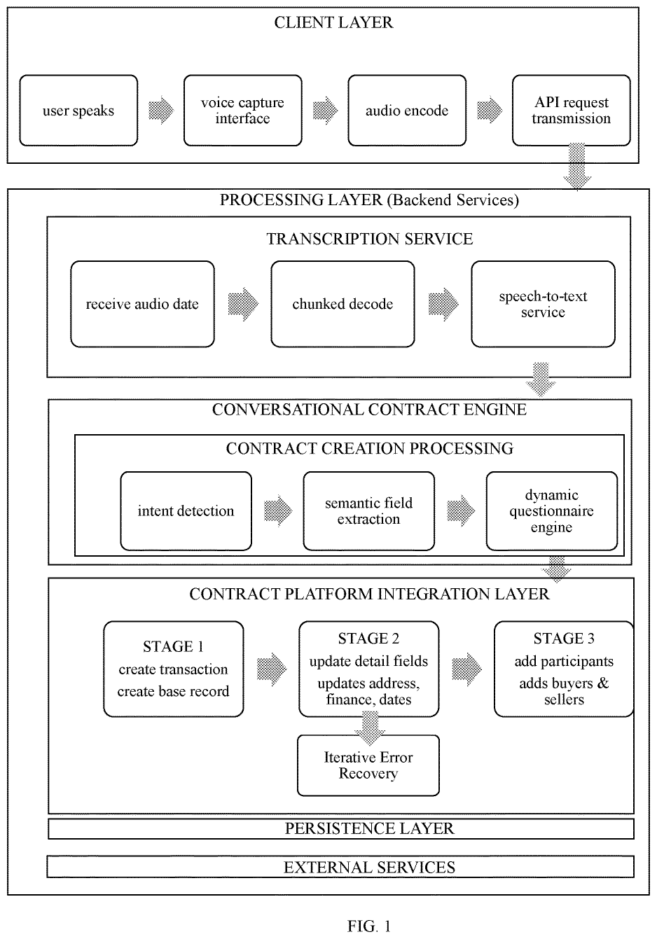

The Voice-Based Dynamic Real Estate Contract Completion System illustrated in FIG. 1 is designed to transform spoken natural language into structured real estate transaction data. The system provides a platform-agnostic bridge between informal human speech and the rigid data requirements of third-party contract management platforms. By utilizing a multi-layered architecture, the system semantically maps conversational statements to structured fields and dynamically adapts its data collection process based on the specific transaction context.

The Client Layer serves as the primary interface for capturing user input. The process initiates when a user provides natural language input via a voice-based command or statement. A Voice Capture Interface may utilize hardware-based or software-based audio capture mechanisms to record the user's speech. The captured audio is encoded into a platform-independent format (e.g., WebM or WAV) suitable for transmission. The encoded audio is transmitted to the processing layer via a Universal Communication Gateway, which in the embodiment illustrated in FIG. 1 is designated API Request Transmission. In some embodiments, the Universal Communication Gateway is an API Request Transmission Module; however, the gateway is configured to support a plurality of data exchange methods, including WebSockets, GraphQL queries, Remote Procedure Calls (RPC), gRPC, event-driven architectures, Model Context Protocol (MCP), MCP-like agent protocols, agent-to-tool interaction systems, request/response REST polling, or direct asynchronous message queuing (e.g., MQTT or AMQP). At the Client Layer, a user speaks naturally to a voice capture interface. The system is configured to capture compound natural language statements—such as an address, names, and price—within a single utterance. This utterance is then encoded and transmitted via the Universal Communication Gateway to a processing layer.

The Processing Layer contains the core logic for interpreting speech and managing the transaction lifecycle. The Processing Layer may comprise a Transcription Service, a Conversational Contract Engine, a Persistence Layer, and/or External Services.

The Transcription Service may be configured to convert raw audio into a text transcript for further analysis. The Transcription Service receives the audio buffer from the Client Layer. To ensure memory efficiency, particularly in serverless environments, the audio may be decoded in manageable chunks. The decoded audio is processed by a speech-to-text service (such as OpenAI Whisper) to produce a text transcript. In one embodiment, this service utilizes an “OpenAI Whisper API,” though it may alternatively employ services like “Google Speech,” “Amazon Transcribe,” or “AssemblyAI” to produce a text transcript.

In some embodiments, the system is configured to process this transcript as a Dynamic Transcription Data Stream—characterized by a real-time text flow where data is transmitted as a sequence of volatile character packets or transient string fragments—such that the transcript may be consumed by downstream modules without requiring persistence in a formal or static text file format. To ensure this process is scalable across varying network conditions and hardware constraints, the system may implement structural configurations such as a Sliding-Window Buffer Controller utilizing a Primary Processing Buffer and a Secondary Pre-Fetch Buffer, a Context-Aware Recursive Decoder utilizing a Persistent State Registry for Inter-Chunk State Reconciliation, or a Reactive Stream Regulator employing a Back-Pressure Signaling Protocol, which are later disclosed in more detail. As seen in FIG. 1, the transcription service comprises a Signal-to-Text Transformation Engine (illustrated in the figure as a speech-to-text service). As used herein, this engine refers to a structural Acoustic-Linguistic Decoder configured to map a temporal audio signal to a digital text representation. While illustrated embodiments may utilize transformer-based neural architectures or large language models (LLMs) specialized for transcription, such as the Whisper model architecture, the engine is configured to execute this transformation via any Probabilistic Phonetic Model that identifies linguistic tokens within a noisy acoustic environment. The Processing Layer may receive audio data at this service, which performs memory-efficient chunked decoding to transform audio data into a text transcript.

Next, To maintain data integrity, the conversational contract engine triggers a name confirmation workflow. In the illustrated embodiment, the system distinguishes between names extracted from an initial compound statement—which are stored as “pending” and trigger a confirmation prompt—and names provided as an “isDirectResponse” to a specific question. Direct responses are accepted immediately without redundant confirmation to optimize conversational flow. Central to this engine is a dynamic questionnaire engine, which manages a ContractDraft state object to determine the next logical question. Many factors are considered in determining the next logical question, which may include the current contract draft state (e.g. what data has been collected), the transaction type (e.g. purchase/lease determines the relevant participants), the previously asked questions to prevent repetition, and/or pending confirmations for prioritization and workflow continuity. The system adapts its questions based on transaction context. A purchase offer only needs buyer names (the seller is discovered through the transaction). A listing only needs seller names. Prior art systems ask the same static set of questions regardless of transaction type, creating unnecessary friction and collecting irrelevant data. Transaction types and example keywords are contained in Table 1 below.

TABLE 1

| Detected Keywords | Mapped Transaction Type |
|---|---|
| purchase, buy, buying, offer | PURCHASE_OFFER |
| listing, sell, selling, list | LISTING_FOR_SALE |
| lease listing, rental listing, | LISTING_FOR_LEASE |
| list for rent | |
| lease offer, rent, rental | LEASE_OFFER |
| other | OTHER |

The engine employs a hierarchical priority evaluation where “Pending Confirmations” always preempt new data collection to maintain context. The engine further employs transaction-type-aware selection logic that only asks for information relevant to the current context, such as asking for “Buyers only” during a “PURCHASE_OFFER” while skipping seller details. The Conversational Contract Engine serves to transform unstructured text into a domain-specific ContractDraft state object. The domain-specific ContractDraft state object is a central data structure that tracks the lifecycle and details of a real estate transaction. It acts as a specialized container that stores collected data, manages conversational progress, and prepares information for downstream platform integration. The “domain-specific” nature refers to its design around real-world real estate workflows, specifically handling the following elements:
1. Transactional Metadata. Transaction Identification: It stores unique identifiers, such as a platform-assigned “transactionld” and a workspace name (e.g., “123 Main St Smith Purchase”). Contextual Categories: The object tracks the “transactionType” (e.g., PURCHASE_OFFER or LISTING_FOR_SALE) and the current lifecycle “status” (e.g., PRE_OFFER or UNDER_CONTRACT).
2. Structured Property and Financial Data. Address Components: It decomposes natural language into specific fields like street number, name, unit, city, state, and zip code. Financial Terms: The object maintains critical transaction values including the purchase price, earnest money amount, and the entity designated as the earnest money holder. Timeline Details: It stores calculated calendar dates for closing, inspection periods, and occupancy.
3. Conversational and Integration State. Progress Tracking: The object maintains arrays like “questionsAsked” to prevent redundant prompts and “fieldsSent” to monitor which data has successfully synced with the contract platform. Confirmation Workflow: It manages internal states for “pending” data (such as “pendingBuyers”) and tracking variables like “awaitingConfirmation” to ensure auto-extracted names or holders are verified by the user before being finalized. Participant Records: It organizes participants into role-specific lists (e.g., “buyers” or “sellers”), including their full names and email addresses.

By maintaining this comprehensive state, the system can dynamically adapt its behavior—such as only asking for buyers during a purchase offer—ensuring the conversation remains relevant to the specific transaction at hand.

The conversational contract engine of the system may further comprise a Contract Creation Processing module, which serves as the primary computational engine for transforming the Transcription Data into a format suitable for the system. This module may implement a series of hierarchical processing stages designed to maintain structural fidelity while operating within a non-persistent memory environment. In the illustrated embodiment, the conversational contract engine may include an intent detection module, a semantic field extraction engine, and a dynamic questionnaire engine.

The conversational contract engine first performs intent detection and transaction type auto-detection to map natural language to specific transaction categories, such as “PURCHASE_OFFER” or “LISTING_FOR_SALE,” based on keyword patterns like “buy,” “offer,” or “listing”. A semantic field extraction engine parses the text for structured data, decomposing a single utterance into a plurality of structured fields simultaneously across multiple canonical categories, such as Property Address, Financials, and Contract Dates. The engine utilizes specialized algorithms for geographic normalization—mapping informal inputs like “d.c.” to “DC” or “District of Columbia”—as well as natural language price multipliers that convert shorthand like “500 k” or “half-million” into “500000”. For financial accuracy, an earnest money parser utilizes a technical regular expression, \d[\d,]*, to capture all digits and handle voice transcriptions that may lack standard comma formatting. The engine also includes a shared last name expansion algorithm that identifies the most likely full name in a sequence and extracts the shared last name to complete earlier partial entries, such as expanding “John and Jane Smith” to “John Smith” and “Jane Smith”.

One such Contract Creation Processing module processing stage may incorporate an Intent Classifier, illustrated as Intent Detection in FIG. 1. Here the Intent Classifier identifies the user's intent, such as “write a contract” or “start a transaction” for a specific address. This module is configured to execute a Transaction Type Auto-Detection Protocol by evaluating the inbound data stream, which may include evaluation against a Keyword-Intent Matrix. Unlike a simple keyword search, this classifier may utilize a Semantic Weighting Algorithm to distinguish between active intents (e.g., “I want to put an offer in”) and hypothetical statements. Upon identifying a valid intent (e.g., “PURCHASE_OFFER”), the classifier initializes a new Transaction-Specific Data Schema (the “ContractDraft” state object) and sets the System-State Monitor to an “Active Drafting” mode.

The engine first executes an Intent Classifier within the Intent Detection framework of FIG. 1 to perform transaction type auto-detection. This module maps natural language to a plurality of specific transaction categories, including “PURCHASE_OFFER,” “LISTING_FOR_SALE,” “LEASE_OFFER,” and “LISTING_FOR_LEASE”, which in one embodiment is done by evaluating the utterance against a Keyword-Intent Matrix. In the illustrated embodiment, the “PURCHASE_OFFER” category is triggered by at least one keyword selected from the group consisting of: “buy,” “buying,” “offer,” “purchase,” or “put in an offer”; the “LISTING_FOR_SALE” category is triggered by at least one keyword selected from the group consisting of: “listing,” “selling,” “list a house,” or “putting it on the market.” One embodiment utilizes a single keyword match, while further embodiments require a cluster of at least two keywords. Furthermore, the system is configured to distinguish residential or commercial rental contexts, where keywords like “lease,” “rent,” or “rental” trigger the “LEASE_OFFER” category or the “LISTING_FOR_LEASE” category based on the presence of possessive or directional auxiliary verbs.

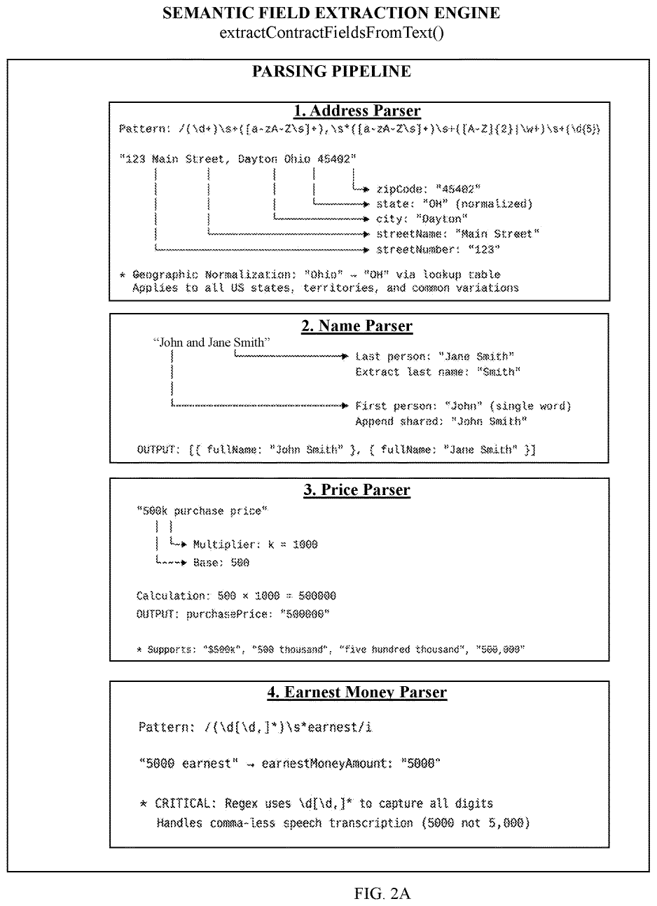

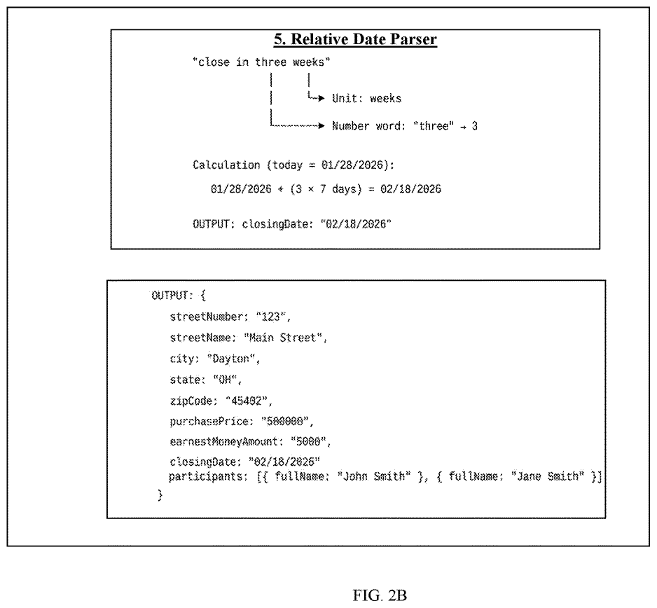

A Semantic Field Extraction engine parses compound natural language statements into structured fields including address components, purchase price, earnest money, and participant names. It utilizes specialized algorithms for shared last name expansion and relative date conversion. This engine may be configured to perform Multi-Slot Extraction, where a single compound natural language statement is decomposed into a plurality of structured data points simultaneously. As illustrated in FIGS. 2A and 2B, the engine activates a suite of specialized Algorithmic Logic Units, including an address parser, a name parser, and a financial parser, as well as a Parser Orchestrator to resolve data ambiguity. The orchestrator assigns a “Structural Fidelity Score” to each extracted token. If a token possesses high phonetic similarity to multiple fields (e.g., a street name that is also a participant's last name), the orchestrator applies a Proximity-Based Priority Logic, favoring the field that is “anchored” by nearby keywords in the transcript.

A Dynamic Questionnaire Engine evaluates the current state of the transaction and determines the next relevant question to ask the user. It dynamically branches based on “transactionType”; for example, it will only ask for buyer names in a purchase offer. The final stage of the processing section is the Dynamic Questionnaire Engine, which functions as a state-machine-driven controller. This engine does not follow a static script; rather, it performs a Recursive State Evaluation at the start of every conversational turn. A Preemption Controller manages the transition between hierarchical priority levels (Priority 1 through 5). If the System-State Monitor detects a new State-Interrupt Signal (e.g., the “awaitingConfirmation” flag is set), the controller programmatically preempts the data collection flow to force a verification event. The engine may be configured to execute Field-Dependency Mutations. For example, the extraction of an “earnestMoneyAmount” triggers a mutation that automatically elevates the “earnestMoneyHeldBy” field to a “Pending” status, thereby modifying the subsequent question-generation logic in real-time.

Then, a Contract Platform Integration Layer abstracts the complexity of third-party communication gateways, which may include APIs, through a multi-stage submission pattern. The Contract Platform Integration Layer is configured to orchestrate the synchronization of the Transaction-Specific Data Schema with at least one external third-party environment. As shown in FIG. 1, the output of the Contract Creation Processing module is received by the Contract Platform Integration Layer via a Validated Payload Interface. This layer then executes the three-stage abstraction (Workspace Creation, Field Population, and Participant Assignment). As illustrated in FIG. 1, this layer implements a three-stage abstraction interface designed to ensure transactional integrity across disparate platform architectures. The Contract Platform Integration Layer may include a Stage 1 transaction workspace creation module, a Stage 2 detailed field population module, and a Stage 3 participant assignment module. Stage 1 involves transaction workspace creation (e.g., a “Loop” in a “Dotloop API” embodiment), followed by Stage 2, detailed field population, and Stage 3, participant assignment. In the illustrated embodiment, Stage 2 incorporates an iterative error recovery mechanism for graceful degradation. If a platform rejects a payload with a 400 status, the system parses the error response to extract “pointers” such as “/Financials/attributes/Field X”. The algorithm then splits this pointer to identify a specific section and attribute, deletes that invalid key-value pair from the payload, and—if a section becomes empty—deletes the entire section before retrying the request. This process repeats until a configured “MAX_RETRIES” is reached or all valid fields are saved. Finally, to ensure continuous operation with replaceable external services, the system implements a platform token refresh flow (e.g., “fetchWithAutoRefresho”) that automatically detects “Unauthorized” 401 errors, requests new tokens using a “refresh_token,” persists them to secure storage, and retries the original request.

Stage 1: Structural Workspace Initialization. Stage 1 creates a Transaction whereby the system creates the base transaction record with core metadata such as the name and transaction type. The first stage comprises a Stage 1 transaction workspace creation module. Upon the dynamic questionnaire engine returning a “complete” status, the system initiates an automated handshake with the target platform's Universal Communication Gateway. The module may be configured to execute a Workspace Provisioning Protocol, which establishes a unique remote container (e.g., a “Transaction Folder” or “Workspace”) associated with the local “user_id”. This stage ensures that a valid destination Uniform Resource Identifier (URI) exists prior to the transmission of sensitive financial or participant data. In one embodiment the base record serves as the “source of truth” that the Status Coercion Algorithm and Weighted Intent Engine will modify as the conversational flow progresses from Stage 1 into the active drafting and validation phases.

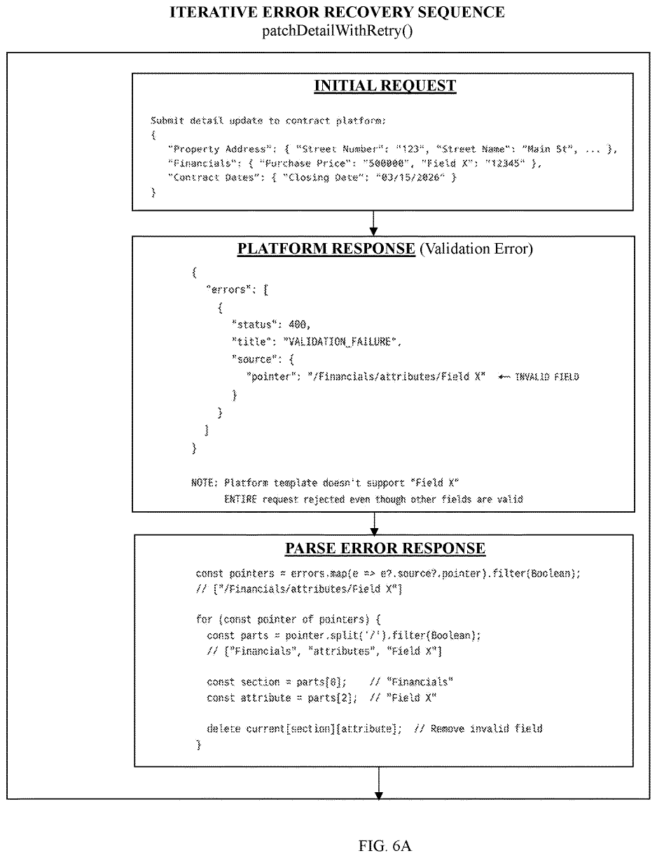

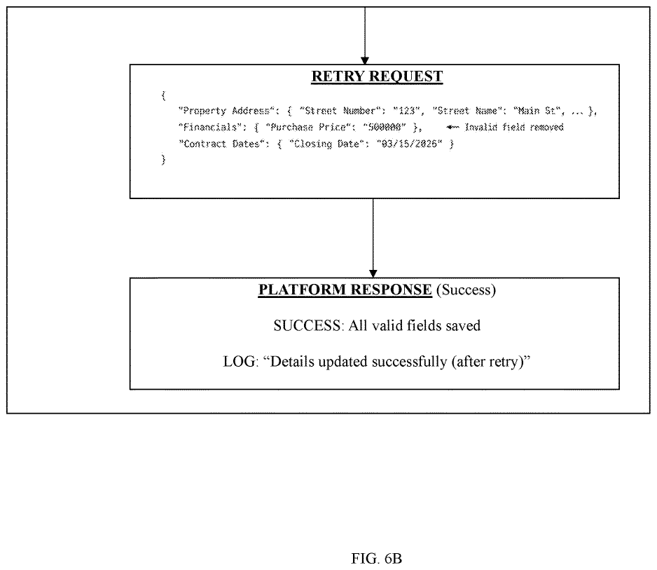

Stage 2: Detailed Field Population and Normalization. Stage 2 updates detail fields and populates nested field sections including property details, financials, and contract dates. The second stage comprises a Stage 2 detailed field population module, functioning as a Universal Payload Formatter. This module is configured to map the local variables (e.g., draft.propertyAddress, draft.purchasePrice) to the specific schema requirements of the external platform. The module may have an Iterative Error Mitigation Architecture. As illustrated in FIGS. 6A and 6B, Stage 2 incorporates an algorithmic “patchDetailWithRetry( )” function. If the external platform returns a validation error (e.g., a 400 status), the system executes a Cross-Schema Mapping Interface to identify the failing field via a URI-style pointer. The module may also utilize an Exclusionary Masking Protocol to prevent a single invalid field from halting the entire integration, the system programmatically executes a masking protocol to delete the offending key-value pair and initiates an Iterative Payload Pruning Sequence. This allows the system to successfully sync the “clean” portions of the contract while flagging the “rejected” portions for later user correction.

Stage 3: Participant Entity Assignment. Stage 3 adds participants thereby assigning transaction parties (e.g., buyers or sellers) with their respective roles and contact information. The third stage may comprise a Stage 3 participant assignment module, which may be programmatically separated from the field population to ensure that legal signatories are only attached to a validated and provisioned workspace. This module may utilize an Atomic State Reconciliation process to transmit a validated participant array. By isolating this as the final stage, the system ensures that participants are not notified or “invited” to a contract draft that has failed Stage 1 or Stage 2 validation.

Additionally, an Iterative Error Recovery module identifies if a downstream platform rejects a payload due to validation errors, parses the error, removes only the invalid fields, and retries the request to preserve as much valid data as possible.

The system may include supporting layers such as a persistence layer and/or an external services. A Persistence Layer may include a conversation state, a transaction cache, and a pending updates queue. The persistence layer manages state information including a conversation state tracking a “user_id,” “status,” and metadata. This layer utilizes “questionsAsked” and “fieldsSent” arrays to create a suppression logic, ensuring the engine only prompts for missing fields that are relevant to the transaction type and have not yet been successfully synced. A transaction cache stores local metadata like a “trans_id” and “last_synced” timestamp, while a pending updates queue holds “proposed_value” and “status” tags for data awaiting batch processing. The Persistence Layer ensures data integrity across multi-turn dialogues. The Persistence Layer is a support structure (storing the Conversation State and “questionsAsked” arrays). The Persistence Layer may act as a State-Recovery Buffer that the Contract Creation Processing module consults to ensure that any Iterative Error Mitigation performed by the integration layer is reflected back into the conversational turn logic (via the “fieldsSent” array).

Thus, at a high level, the Persistence Layer acts as a reliable state manager. In a voice-based environment, users may experience network drops, or the AI may need to “pause” to wait for external API responses. The Persistence Layer ensures that every spoken data point, once validated, is “checkpointed”. This allows the agent to resume a session exactly where they left off without losing previous answers, effectively decoupling the real-time conversation from the final contract generation. The Persistence Layer may maintain a Sync-State Database that tracks the status of every field in the Standardized Transaction Object (STO). When a user verbally provides or updates a value (e.g., changing a purchase price), the layer marks that specific data slot with a “dirty-flag”. This allows for Differential Synchronization, where the system only resubmits the specific “dirty” fields to the external communcation gatewasys, rather than re-processing the entire contract, which reduces bandwidth and processing overhead. In one embodiment, to manage the “persistence” of real-time audio, the architecture utilizes a Sliding-Window Buffer. This controller manages the handover between a Primary Processing Buffer (active transcription) and a Secondary Pre-Fetch Buffer (stored audio data). If a connection is interrupted, the Persistence Layer holds the un-processed audio in the buffer until the state-machine confirms it has been successfully converted to text and mapped to the STO. The persistence layer may also store the metadata behind the Status Coercion Algorithm. When a field is programmatically “coerced” from PENDING to FORCED_VALID, the Persistence Layer attaches an Auto-Annotation Tag to that field. This ensures that the reason for the coercion (e.g., persistent low confidence scores) is persisted and can be recalled during the final Agent Review and Approval stage, providing a technical audit trail for legal compliance. Further, within the infrastructure level, the Persistence Layer manages authentication session states via Token-Refresh Semaphores. This logic prevents redundant and conflicting authentication refresh cycles during concurrent communication gateway tasks. By persisting the “refresh status,” the system ensures that multiple background tasks (like mapping and validation) do not crash the session by attempting to refresh security tokens simultaneously. As a differential sync-state manager and a buffer controller, the Persistence Layer provides a specific technical solution to the problem of data loss in voice-to-text workflows.

The Integration Layer is the production destination. The processing module is the “Gatekeeper” that decides when the data is “mature” enough to move from the internal cache to the external platform.

The External Services are such that the system may be replaceable and platform-independent, allowing for integration with various third-party speech recognition providers and contract management platforms; such as speech-to-text services including, but not limited to, OpenAI Whisper, Google Speech, Amazon Transcribe, and/or AssemblyAI, as well as contract platforms including, but not limited to, DotLoop, SkySlope, Brokermint, and/or DocuSign Rooms.

Referring to FIGS. 2A and 2B, a detailed view of a semantic field extraction engine is provided, illustrating a parsing pipeline configured to extract a plurality of structured fields from a single compound natural language statement, specifically the execution of the “extractContractFieldsFromText( )” function. This engine transforms a single, unstructured natural language compound statement into a structured data object containing multiple discrete contract fields. The parsing pipeline utilizes domain-specific logic to normalize geographic data, expand participant names, calculate financial values, and convert relative temporal expressions into exact calendar dates. In the illustrated embodiment, the parsing pipeline receives an input string, for example: “write a contract for 123 Main Street, Dayton Ohio 45402 for John and Jane Smith, 500 k purchase price, 5000 earnest, close in three weeks”. As illustrated in FIG. 2A, the parsing pipeline may include an address parser, a name parser, a price parser, an earnest money parser, and/or a relative date parser, which is seen in FIG. 2B. One embodiment includes at least 2 of the parsers, while further embodiments include at least 3, 4, or all 5 of the parsers.

An address parser is configured to apply a technical pattern to the input string to identify individual geographic components. Specifically, the address parser may utilize a structured regular expression, such as /(\d+)\s+([a-zA-Z\s]+),\s*([a-zA-Z\s]+)\s+([A-Z]{2}w+)\s+(\d{5})/, to isolate data into specific capture groups. For the exemplary input “123 Main Street, Dayton Ohio 45402,” the address parser extracts a street number “123,” a street name “Main Street,” a city “Dayton,” a state, and a zip code “45402”. In the illustrated embodiment, the engine performs a conditional transform on the state capture group; if the group identifies a full state name rather than a two-letter code, the address parser may trigger geographic normalization logic to convert the full name, such as “Ohio,” into a standardized two-letter code, “OH”.

The parsing pipeline further includes a name parser, which may utilize a “shared last name expansion” algorithm to process participant names. As shown in the illustrated embodiment of FIG. 2A, the name parser identifies “John and Jane Smith” within the input string. The name parser may be configured to first count the parts of the last person mentioned, “Jane Smith”; if the last person has at least two parts (representing a first and last name), the engine extracts the final part as a “sharedLastName”, which in this example is “Smith”. The engine then identifies the first person mentioned as a single word, “John,” and because it consists of only a single part, the engine automatically appends the “sharedLastName” to create a complete name record, “John Smith”. By contrast, if a preceding name already contained multiple parts, such as “John Doe and Jane Smith,” the engine is configured to preserve both full names without expansion. This results in an output containing two complete participant records: “John Smith” and “Jane Smith”.

A price parser is provided to identify and calculate numeric values from informal shorthand. The Price Parser identifies the contract purchase price by recognizing numeric values and natural language multipliers. Referring to FIG. 2A, the price parser identifies “500 k purchase price” in the exemplary input. The parser is configured to identify a base value of “500” and a multiplier “k” representing “1000”. In such an embodiment the engine performs a calculation ($500 times 1000$) to generate a numeric purchase price of “500000”. In the illustrated embodiment, the price parser is configured to support various natural language formats, including “$500 k,” “500 thousand,” “five hundred thousand”, and “half million”.

Additionally, an earnest money parser is included in the pipeline to extract deposit information. The Earnest Money Parser specifically targets deposit and escrow values. In the illustrated embodiment, the earnest money parser utilizes a technical regular expression, \d[\d,]*, specifically designed to capture all digits in a sequence. This allows the parser to accurately process comma-less speech transcriptions, such as “5000 earnest,” and extract an “earnestMoneyAmount” value of “5000”. The earnest money parser may also be configured to support various natural language formats, including “$5 k,” “5G,” and “50 Franklins” and the disclosure of the price parser.

Referring now to FIG. 2B, the parsing pipeline further includes a relative date parser. The relative date parser is configured to convert informal temporal expressions into exact calendar dates and exact date formats required by contract management platforms. The system may maintain a number word mapping dictionary that maps non-numeric strings, such as “one” through “ninety,” to corresponding integers. For the exemplary input “close in three weeks,” the parser identifies the number word “three,” which is mapped to the integer “3,” and a unit “weeks”. The engine may then performs unit-based arithmetic where the identified unit acts as a multiplier for the integer (e.g., weeks $\times$7 days). Utilizing a reference date (e.g., today=01/28/2026), the engine calculates the target date by adding 21 days to reach a “closingDate” of “02/18/2026”.

FIG. 2B concludes with the resulting Structured Output Object, representing the final state of the ContractDraft object after the parsing pipeline is complete. All semantically extracted data points—address components, normalized state, expanded participant names, calculated price, earnest money, and calculated closing date—may be organized into a single JSON-compatible structure ready for multi-stage integration with the target contract platform. The final output of the semantic field extraction engine is a structured data object. In the illustrated embodiment, the output aggregates the data extracted by each parser into a standardized format, including the “streetNumber” (“123”), “streetName” (“Main Street”), city (“Dayton”), state (“OH”), “zipCode” (“45402”), “purchasePrice” (“500000”), “earnestMoneyAmount” (“5000”), “closingDate” (“02/18/2026”), and a participants array containing the full names of “John Smith” and “Jane Smith”. This structured output is then ready for further processing, which in some embodiments is performed by the dynamic questionnaire engine or for transmission to a downstream contract management platform.

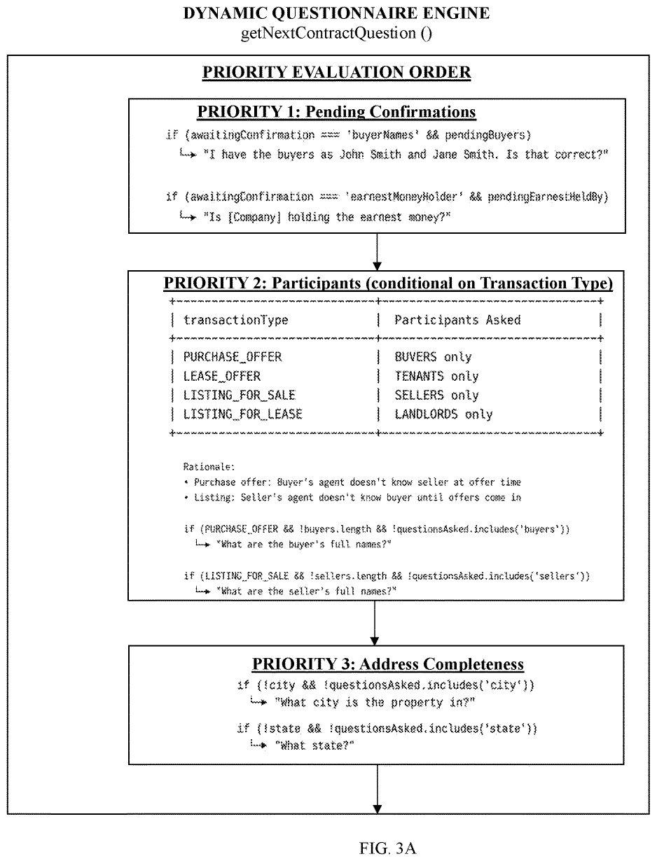

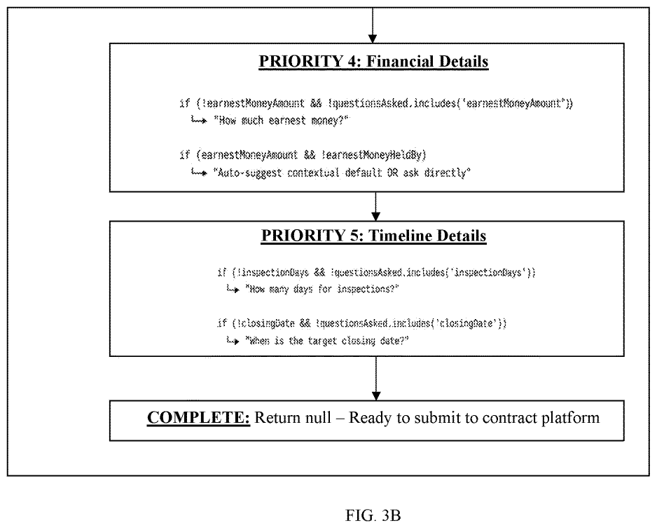

FIG. 3A and FIG. 3B illustrate the Dynamic Questionnaire Engine, which executes the getNextContractQuestion( ) function. This engine represents a central technical innovation of the system, distinguishing it from prior art static form-filling interfaces by dynamically adapting question sequencing in real-time based on transaction context, previously collected data, and pending state confirmations. The engine utilizes a Priority Evaluation Order to minimize user friction and ensure that only domain-relevant information is requested. A detailed view of a dynamic questionnaire engine is provided, illustrating a state-machine-driven process for determining an optimal sequence of follow-up inquiries. In the illustrated embodiment, the dynamic questionnaire engine receives an input comprising a “ContractDraft” state object. As used herein, a “state object” refers to a structural Transaction-Specific Data Schema—a multi-dimensional data container persisted in memory or a database—configured to maintain the current resolution status of a plurality of transaction variables. The “ContractDraft” state object functions as the central repository for reconciling extracted semantic fields with the required constraints of a formal legal document. In some embodiments, the “ContractDraft” represents a logical grouping of transaction data that may be persisted across a distributed architecture, including a transaction cache and a pending updates queue, to ensure state is maintained regardless of specific variable storage formats. The transition between hierarchical priority levels may be managed by a structural Preemption Controller executing an Interrupt-Driven Re-evaluation.

In some embodiments, the “ContractDraft” represents a logical grouping of transaction data that may be persisted across a distributed architecture, including a transaction cache and a pending updates queue, to ensure state is maintained regardless of specific variable storage formats. The engine utilizes this state object to determine which question to ask next based on a current transaction state and previously collected data, thereby enabling a conversational interface that dynamically adapts to a user's specific context.

As illustrated in FIGS. 3A and 3B, the dynamic questionnaire engine executes a priority evaluation order consisting of a plurality of hierarchical priority levels. In the illustrated embodiment, the engine first evaluates “Priority 1,” which is associated with pending confirmations. In some embodiments, the transition to “Priority 1” is controlled by a priority preemption flow where the engine re-evaluates this level at the start of every conversational turn; if the user's latest statement provides new data that triggers a “pending” status for a field, the system immediately resets the evaluation to “Priority 1”. In some embodiments, the state object includes a dedicated “awaitingConfirmation” property that acts as a global interrupt for the dynamic questionnaire engine, such that when a semantic extractor populates a “pending” field, it simultaneously sets the “awaitingConfirmation” flag to a specific field identifier. This level prioritizes maintaining conversational flow by verifying auto-extracted data before seeking new information. For example, if the state object indicates that buyer names are awaiting confirmation, the engine generates a prompt such as, “I have the buyers as John Smith and Jane Smith. Is that correct?”. Stated another way, if the user's statement provides new data that triggers a “pending” status, the system resets the evaluation to Priority 1. The state object includes an “awaitingConfirmation” flag. As used herein, a “flag” refers to a structural State-Interrupt Signal—a binary or enumerated metadata attribute within the Transaction-Specific Data Schema—configured to programmatically trigger a specific branch of logic within the dynamic questionnaire engine. When set, the State-Interrupt Signal acts as a global interrupt, diverting the engine's processing flow from data collection to data verification. If a Heuristic Verification Gate determines that a structural fidelity score for a field is below a threshold, the system is programmatically forced to set the “awaitingConfirmation” flag and trigger a Priority 1 prompt, such as, “I have the buyers as John Smith and Jane Smith. Is that correct?”.

Moving from “Priority 1” to “Priority 2” occurs only if a specific Boolean gate is satisfied, such as “IF (draft.awaitingConfirmation==null)”. “Priority 2” is associated with participant collection and is highly conditional on a “transactionType,” representing a key point of dynamic adaptation. Unlike prior art static forms that ask all participant questions regardless of context, this system dynamically adapts questions based on transaction context, such as whether a transaction is a purchase or a listing. In some embodiments, the system utilizes a mutual exclusion mapping table where, if the “transactionType” is a “PURCHASE_OFFER,” fields associated with “Sellers” are flagged as inaccessible to the engine to prevent irrelevant prompts. For a “PURCHASE_OFFER” or “LEASE_OFFER,” the engine is configured to ask for buyers or tenants only, whereas for a “LISTING_FOR_SALE” or “LISTING_FOR_LEASE,” the engine asks for sellers or landlords only. The engine further employs a suppression logic mechanism that performs a double-negative check: a question is only generated if a field is both empty and has not been previously flagged in a “questionsAsked” array.

Thus, a key innovation of the engine is its ability to branch logic based on the “transactionType” identified in the intent detection phase. Branching Logic is used when the system maps specific transaction types to required participants as illustrated in the provided table:
PURCHASE_OFFER/LEASE_OFFER: The engine only requests Buyers or Tenants, respectively.
LISTING_FOR_SALE/LISTING_FOR_LEASE: The engine only requests Sellers or Landlords, respectively.

This domain-specific optimization reflects real-world workflows where, for instance, a buyer's agent at the offer stage does not yet know the seller's information.

Moving from “Priority 2” to “Priority 3” occurs only if the gate “IF (participants.length>0)” is met. “Priority 3” is associated with address completeness and dynamically prompts for missing components, such as a “city” or “state,” only if those specific fields are empty in the “ContractDraft” state object and have not been previously asked. Stated another way, moving to “Priority 2” (Participant Collection) occurs if draft.awaitingConfirmation==null.

This is highly conditional on the “transactionType”. In some embodiments, the system utilizes a Mutual Exclusion Mapping Table or a “Contextual Constraint Matrix” where fields associated with irrelevant transaction roles (e.g., Sellers in a Purchase Offer) are flagged as “Inaccessible State”. For a “PURCHASE_OFFER” or “LEASE_OFFER,” the engine is configured to ask for buyers or tenants only, whereas for a “LISTING_FOR_SALE” or “LISTING_FOR_LEASE,” the engine asks for sellers or landlords only. The engine further employs a Double-Negative Suppression Gate or “Historical Query Suppression Gate” where a question is only generated if a field is both empty and has not been previously flagged in a “questionsAsked” array. Once participants are identified, the engine evaluates the ContractDraft for missing property location data; for example, if the city or state fields are null and have not yet been queried, the engine triggers specific prompts such as “What city is the property in?”.

Moving from “Priority 3” to “Priority 4” occurs once the property address is complete. Referring to FIG. 3B, “Priority 4” is associated with financial details. The engine dynamically adapts to the presence of an “earnestMoneyAmount”. In some embodiments, the engine utilizes mutation logic where setting an “earnestMoneyAmount” automatically triggers a “pending” status for the “earnestMoneyHeldBy” field, thereby mutating the priority of related fields within the state object. In some embodiments, the “Persistence Layer” maintains a “Transaction Cache” that stores a “workspaceName” attribute such that if the “earnestMoneyHeldBy” field is null and a “workspaceName” is available, the system retrieves the “workspaceName” and injects it into a “pendingEarnestMoneyHeldBy” temporary variable to trigger the “Priority 1” confirmation workflow. If an amount is present but a holder is not, the engine may trigger an auto-suggestion of a contextual default or ask for the holder directly. Thus, the system may incorporate Earnest Money Logic such that if an earnest money amount is missing, the engine asks, “How much earnest money?”. Further, the system may incorporate Auto-Suggestion logic such that if an amount exists but a holder is not specified, the engine triggers an auto-suggestion workflow to propose a contextual default (e.g., the listing brokerage).

Moving from “Priority 4” to “Priority 5” occurs once financials are complete. “Priority 5” is associated with timeline details, such as “inspectionDays” and a target “closingDate”. The engine continues to dynamically adapt its output by evaluating the state object for any remaining empty fields. The final priority level addresses the temporal constraints of the transaction. For instance, the engine checks for inspection periods and target closing dates, generating prompts such as “How many days for inspections?” if the fields are empty.

As illustrated in FIG. 3B, in one embodiment once all required information has been collected, the engine returns a null value, indicating that the state is complete and ready for submission to a downstream contract platform. This multi-level priority evaluation emphasizes the system's core innovation: while prior art is restricted to static forms that ask all questions regardless of context, this system repeatedly and dynamically adapts its questioning based on (1) “transactionType,” (2) previously collected data, and (3) pending confirmations.

In one embodiment, the system implements a three-tier field mapping architecture designed to decouple natural language extraction from the rigid schema requirements of third-party contract management platforms. The dynamic questionnaire engine may include a Status Normalization and Validation algorithm whereby the input is a natural language status string, which for example may be the transaction type. Different third-party services may use different tags for the same piece of information, such as the transaction type. Thus, for this example the output of this algorithm is a valid platform-compatible status code. An status normalization map is included in Table 2 below.

TABLE 2

| User Input | Normalized Status |
|---|---|
| pre-offer, preoffer | PRE_OFFER |
| under contract, in contract, pending | UNDER_CONTRACT |
| sold, closed | SOLD |
| active, active listing | ACTIVE_LISTING |
| pre-listing, prelisting | PRE_LISTING |
| private, private listing | PRIVATE_LISTING |
| leased, rented | LEASED |

In one embodiment the architecture first maps extracted semantic values into a platform-agnostic Standardized Transaction Object (STO). This layer acts as a “source of truth” where data is stored in a normalized format before being translated for third-party communication gateways (e.g. external APIs). For example, the system may utilize a normalized Canonical Slot such as financials.earnest money.amount and/or dates.closing_date.value, which may later be transformed into a specific format for the intended communication gateway. Once the STO layer reaches a defined confidence threshold (e.g., $IntentScore>0.90$), a Platform-Specific Adapter executes a translation service to map the canonical slots to the unique, proprietary field names of the target destination. Table 3 below contains platform-agnostic field categories.

TABLE 3

| Category | Fields |
|---|---|
| Property Address | Street Number, Street Name, Unit, City, State/Province, Postal Code, County, Country |
| Financials | Purchase/Sale Price, Earnest Money Amount, Earnest Money Held By, Rent, Security Deposit |
| Contract Dates | Closing Date, Contract Date, Expiration Date |
| Offer Dates | Inspection Period End, Occupancy Date |
| Property Details | Year Built, Bedrooms, Bathrooms, Square Footage, Lot Size |

For instance, the canonical STO field of earnest money.amount may be automatically transformed into field_202_EM_val for platform A and transformed into Contract_EM_Amount for platform B. Similarly, the canonical STO field of buyer.legal_name may be automatically transformed into buyer name full for platform A and transformed into primary_party_1_nm for platform B. Likewise, the canonical STO field of property.address_line 1 may be automatically transformed into site_addr_str for plarform A and transformed into subject_property_loc for platform B.

The architecture may further comprise Conditional Mapping Logic, where the population of one platform-specific field name is contingent upon the value of another. For example, if the natural language engine identifies a “Financing” transaction type, the system may automatically ignore certain fields in the different platforms, and it needs to know the platform specific nomenclature to ignore. For instance, the system will therefore ignore the field_99_cash_verif field in Platform A and instead prioritize the population of field_101_lender_name. Further, the system may also maintain a Field-Exclusion Matrix to ensure that conflicting platform-specific fields (e.g., “FHA Financing” vs. “VA Financing”) cannot be simultaneously mapped within the same transaction instance. To maintain data integrity during the mapping process, each platform-specific field is associated with a Sync-State Metadata Tag. Additionally, When a user verbally updates a value (e.g., changing a price), the corresponding canonical slot is marked with a “dirty-flag”, which may then be used by the system for differential synchronization whereby it identifies only the fields marked as “dirty” and executes a localized PATCH request to the specific platform-specific field name (e.g., updating only field_202_EM_val), rather than re-transmitting the entire contract payload.

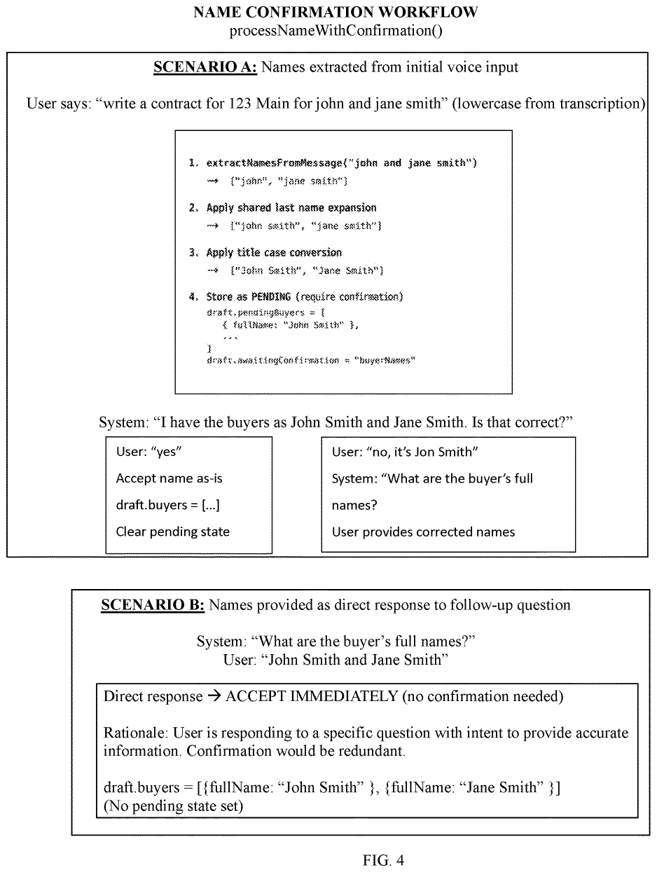

Referring now to FIG. 4, a detailed view of a Name Confirmation Workflow is provided, specifically illustrating the logic of a “processNameWithConfirmation( )” function. In the illustrated embodiment, a primary purpose of this workflow is to ensure the absolute accuracy of participant names extracted from potentially imprecise voice transcriptions. This workflow represents a critical optimization in the system's conversational logic, designed to ensure the high fidelity of participant names while minimizing redundant user interactions. The system distinguishes between names that are auto-extracted from a broader initial utterance and those provided as a direct response to a specific system query, applying different validation rules to each. Unlike prior art systems that either accept transcribed text blindly or require manual field-by-field entry, this system implements a novel “bifurcated name-origin logic” that distinguishes between names “extracted” from a compound statement and names provided as a “direct response” to a specific inquiry. In some embodiments, the “bifurcated name-origin logic” may be supported by a source-type metadata tag (e.g., “SOURCE_EXTRACTED” or “SOURCE_DIRECT”) appended to extracted fields to programmatically determine if a “pending” state is required. This technical distinction is critical for preventing redundant confirmation prompts—thereby reducing user friction—while simultaneously ensuring high data integrity for auto-extracted names that may suffer from formatting or transcription issues.

Stated another way, FIG. 4 illustrates an embodiment of a detailed view of a name confirmation workflow is provided, specifically illustrating the logic of a “processNameWithConfirmation( )” function. In the illustrated embodiment, the system implements a “bifurcated name-origin logic” that distinguishes between names “extracted” from a compound statement and names provided as a “direct response” to an inquiry. This logic is supported by a Source-Origin Metadata Tag (e.g., “SOURCE_EXTRACTED” or “SOURCE_DIRECT”). The distinguishing of name origin results in a Conditional State Gate that controls the subsequent data processing pipeline. In the case where the Source-Origin Metadata Tag identifies a record as “SOURCE_EXTRACTED,” the system programmatically triggers a Verification-Required State within the Transaction-Specific Data Schema, which forces the State-Interrupt Signal to remain ACTIVE and restricts the dynamic questionnaire engine from progressing to lower priority levels. Conversely, when the Source-Origin Metadata Tag identifies a record as “SOURCE_DIRECT,” the system executes a Verification-Bypass Protocol, which programmatically clears the State-Interrupt Signal and marks the field as “Validated,” allowing the system to immediately commit the data to a persistent data store without human-in-the-loop intervention.

Referring now to FIG. 4, a detailed view of a name confirmation workflow is provided, specifically illustrating the logic of a “processNameWithConfirmation( )” function. In the illustrated embodiment, a primary purpose of this workflow is to ensure the absolute accuracy of participant names extracted from potentially imprecise voice transcriptions. Unlike prior art systems that either accept transcribed text blindly or require manual field-by-field entry, this system implements a novel “bifurcated name-origin logic” that distinguishes between names “extracted” from a compound statement and names provided as a “direct response” to a specific inquiry. In some embodiments, the “bifurcated name-origin logic” may be supported by a source-type metadata tag (e.g., “SOURCE_EXTRACTED” or “SOURCE_DIRECT”) appended to extracted fields to programmatically determine if a “pending” state is required. This technical distinction is critical for preventing redundant confirmation prompts-thereby reducing user friction—while simultaneously ensuring high data integrity for auto-extracted names that may suffer from formatting or transcription issues.

As illustrated in FIG. 4, the system handles data through two primary technical scenarios. In “SCENARIO A,” names are extracted from an initial voice input, such as a user stating: “write a contract for 123 Main for john and jane smith”. Because voice-to-text transcriptions frequently produce lowercase output (e.g., “john and jane smith”), the system initiates a multi-step semantic refinement process comprising a State-Aware Normalization Protocol. In the illustrated embodiment of “SCENARIO A,” the refinement process includes: semantic splitting, shared last name expansion, title case conversion, phonetic similarity auto-correction, part-count verification, and/or awaiting confirmation state.

In some embodiments, the system implements a structural Heuristic Confidence Comparator to perform phonetic similarity auto-correction. The comparator is configured to calculate a Normalized Similarity Metric (e.g., a Levenshtein distance score) between the Volatile Transcription Token and a plurality of entity records retrieved from a Recursive Entity Resolver. The system further implements a Similarity Threshold Gate; if the metric exceeds a predefined threshold, the comparator is programmatically forced to execute a Canonical String Replacement (e.g., correcting ‘Jon’ to ‘John’) prior to confirmation. In further embodiments, the resolver assigns a higher Probabilistic Weight to entities retrieved from a User-Specific Transaction History to perform Contextual Re-Biasing of the correction logic.

Semantic Splitting: An “extractNamesFromMessage( )” function decomposes the string into individual entities, such as [“john”, “jane smith” ]. In some embodiments, this function may utilize regex-based semantic delimiters, such as “/\s*(?:,\s*(?:and\s+)?|(?:and|&)\s+)\s*/i”, to identify complex natural language lists as distinct semantic units including those utilizing ampersands or various comma-and combinations. Regex-based semantic delimiters are specific character patterns, such as ‘$’ symbols or keyword phrases like “purchase price,” used within a regular expression to identify the boundaries of a particular data type in unstructured text. These delimiters allow the system to accurately “slice” a compound statement into discrete, domain-specific fields such as address components, financial amounts, or relative dates. The Semantic Splitting may utilize a Pattern-Matching Engine, also referred to as the Semantic Field Extraction Engine, which is a core component of the Conversational Contract Engine that transforms unstructured natural language into structured, platform-independent contract data. It operates as a parsing pipeline that identifies specific real estate data types using domain-specific regex patterns and semantic delimiters. The engine is designed to “slice” a compound statement-a single sentence containing multiple data points-into discrete fields.

Shared Last Name Expansion: A shared last name expansion algorithm identifies a terminal last name (“Smith”) and programmatically appends it to preceding single-word names to generate complete records, such as [“john smith”, “jane smith” ]. In some embodiments, the engine may perform a “part-count verification” where the expansion algorithm is triggered only if the terminal segment contains at least two parts and the preceding segment contains only one.

Title Case Conversion: The engine applies a “toTitleCase( )” function to normalize the names for formal legal documentation, resulting in “John Smith”, “Jane Smith”. In some embodiments, the system may further utilize a phonetic similarity algorithm, such as Soundex or Levenshtein distance, to compare the extracted string against a profile history or known entity database to perform an auto-correction of likely transcription errors (e.g., correcting “Jon” to “John”) prior to confirmation.

Awaiting Confirmation State: To ensure the accuracy of this algorithmic expansion, the system executes an Awaiting Confirmation State and stores the results as “PENDING” in a “ContractDraft” state object (e.g., “draft.pendingBuyers”). The “awaitingConfirmation” flag is set to “buyerNames,” which triggers the dynamic questionnaire engine to generate a specific verification prompt. In some embodiments, the system dynamically constructs the verification prompt by concatenating a functional prefix (e.g., “I have the buyers as”), a “formattedNames” variable containing the expanded strings, and a functional suffix (e.g., “. Is that correct?”).

In some embodiments, the system may execute a name-part validation protocol and a non-name data protocol, acting as a “Semantic Gatekeeper”, prior to establishing the awaiting confirmation state. The non-name data protocol may utilize a “notNameWords” array to identify and filter common non-name keywords such as “the,” “an,” “is,” “inspection,” “close,” “closing,” “weeks,” and “days”; if a “looksLikeValidNameo” function identifies a match with these keywords, it may suppress the confirmation workflow to prevent the processing of non-name data. Similarly, the name-part validation protocol may enforce specific part-count thresholds, such as requiring a formatted name to consist of at least two parts but no more than five parts to be considered a valid candidate for the confirmation workflow.

In another embodiment, this state refers to a Logic-Gating Mode where the dynamic questionnaire engine is programmatically restricted from progressing to subsequent hierarchical priority levels until the active State-Interrupt Signal is resolved. During this state, the system initiates a structural Verification Prompt Generator. The generator executes a Template-Based Concatenation Logic to dynamically construct a verification prompt by combining a functional prefix (e.g., “I have the buyers as”), a “formattedNames” variable containing the expanded strings, and a functional suffix (e.g., “. Is that correct?”). Simultaneously, the system executes a State-Dependent Input Routing protocol, where the input interface is configured to prioritize the detection of Affirmative/Negative Intent Tokens (e.g., “yes” or “no”) to reconcile the pending data within the Transaction-Specific Data Schema.

As further illustrated in FIG. 4, the system is configured to process the user's verification response through an Atomic State Reconciliation process. If the user provides an affirmative response (e.g., “yes”), the names are accepted as-is and moved to a primary array within the state object configured to hold validated participant data, such as a “draft.buyers” array via a Transactional State Committing step. In some embodiments, this “move” may involve a transactional state committing step where data is mapped to the “buyers” array, the “awaitingConfirmation” flag is set to “null,” and the field is recorded in a “fieldsSent” array to reconcile synchronization status with external platforms. In some embodiments, the system utilizes a “Source-of-Truth Orchestrator” to manage the delta between the “pending” input and the validated participant data array. The system may recognize a wide range of affirmative response patterns via an “affirmativePatterns” array, including “yeah,” “yep,” “correct,” “right,” and “okay,” to facilitate the accurate clearing of the pending state.

Conversely, if the user rejects the suggestion (e.g., “no, it's Jon Smith and Jane Smith”), the system is programmatically forced to reset the state and ask an open-ended follow-up: “What are the buyer's full names?”. In some embodiments, the engine may perform a partial confirmation reconciliation step where it compares the rejection input to the “PENDING” state data to identify and retain correctly extracted segments while updating only the corrected entities. In some embodiments, the system may implement a prefix removal protocol utilizing a regex to strip rejection prefixes such as “no,” “nope,” “actually,” “it's,” or “its” from the user response before processing the remaining string as the corrected name.

Thus, because the initial transcriptions may be informal or improperly cased, the system applies a multi-step refinement process before finalizing the data. This may include an Extraction and Refinement Module, which as illustrated in the example where a user says, “write a contract for 123 Main for john and jane smith,” the system first executes extractNamesFromMessage( ) to isolate the individual names. It then applies Shared Last Name Expansion to complete the partial name “john” and Title Case Conversion to correct the lowercase transcription. It may further include Pending State Module, whereby unlike direct inputs, these refined names are initially stored in a “PENDING” state within the ContractDraft object (e.g., draft.pendingBuyers). The system sets an awaitingConfirmation flag to trigger a verification prompt. If may also include a Confirmation Logic Module, whereby the system presents the formatted names to the user for verification (e.g., “I have the buyers as John Smith and Jane Smith. Is that correct?”). Then, if the user provides an affirmative response (“yes”), the names are accepted into the permanent draft.buyers record, and the pending state is cleared. However, if the user rejects the names (“no, it's Jon Smith”), the system clears the pending state and reverts to an open-ended question to capture corrected information.

In “SCENARIO B,” the system illustrates the handling of names provided as a direct response to such a follow-up question via Direct-Entry Intent Logic. In this scenario, the user responds to the specific prompt “What are the buyer's full names?” with “John Smith and Jane Smith”. In the illustrated embodiment, because the user is responding to a targeted system inquiry, the engine infers a high degree of intent and accuracy. Consequently, the system is configured to accept these names immediately and populate the validated participant data array, such as the “draft.buyers” array, without setting a “pending” state or requiring a second confirmation. In some embodiments, a direct response interrupt may occur when the system is in an active “Listening” state for a specific field-specifically signaled by an “isDirectResponse” Boolean variable being set to true-allowing a “Bifurcated Name-Origin Logic” to bypass the extraction pipeline and route data directly to the validated array. Upon population of the participant data, the system may automatically assign a role string, such as “BUYER” or “SELLER,” to the record based on the current “transactionType” to facilitate orchestrated submission to an external platform.

This state-aware “bifurcated name-origin logic” represents a significant departure from prior art dictation or form-filling systems. By intelligently identifying when an algorithmic expansion requires human verification versus when a direct human input should be treated as canonical, the system provides a technical solution to the inherent ambiguity of voice-based data entry in high-stakes legal environments.

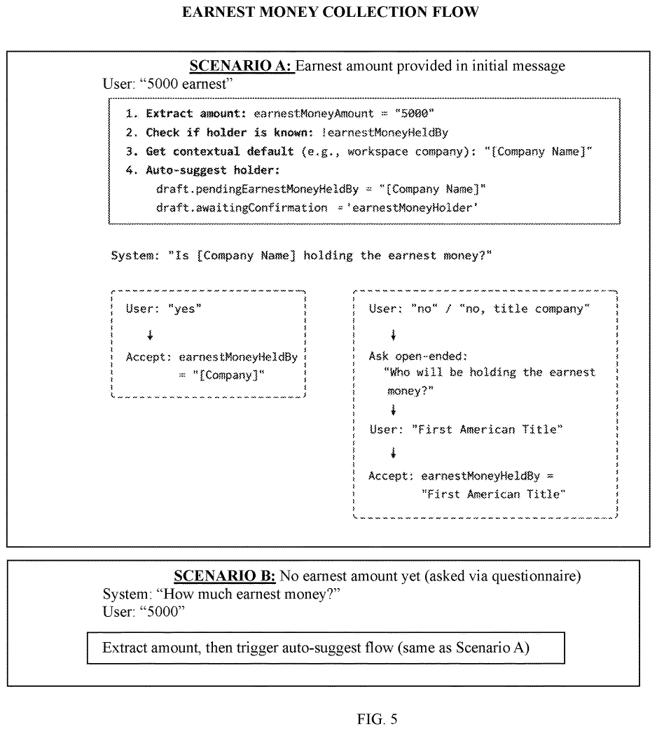

FIG. 5 illustrates the Earnest Money Collection Flow, which represents a specialized logic branch within the Conversational Contract Engine. The purpose of this flow is to reduce user friction by automatically suggesting contextual defaults for the entity holding earnest money (e.g., a brokerage or title company). The system dynamically triggers this workflow whenever an earnest money amount is identified, regardless of whether that data was provided in an initial utterance or a follow-up response. A detailed view of an earnest money collection flow is provided, illustrating the logic of an “auto-suggestive field mutation” protocol. In the illustrated embodiment, the primary purpose of this workflow is to intelligently predict and populate the holder of earnest money based on the extraction of a financial amount. Unlike prior art systems that treat “earnest money amount” and “earnest money holder” as two unrelated data points in a static form, this system implements a novel “contextual default auto-suggestion” that leverages domain-specific patterns in real estate transactions. Specifically, the system operates on the technical rationale that in the vast majority of transactions, a specific party—often the listing brokerage or a designated workspace company—holds the earnest money. By auto-suggesting this contextual default, the system reduces conversational friction for the most common transaction case while maintaining a robust error-recovery mechanism for alternative scenarios.

As illustrated in FIG. 5, the system manages the earnest money collection through two primary technical scenarios and initiates a Financial Amount-to-Holder Dependency Mutation. In “SCENARIO A,” the financial amount is provided in an initial compound voice message, such as “5000 earnest”. In some embodiments, the system may first execute a financial relevance protocol that checks the “transactionType” to determine if earnest money fields are relevant to the current legal context; if the type is “LISTING_FOR_LEASE” or “LEASE_OFFER,” the system may be configured to skip the earnest money flow and redirect the mutation logic to alternative fields, such as a security deposit. Upon receipt of a relevant input, the system initiates the following multi-step automated refinement process:

Financial Extraction: The system extracts the numeric value and populates the “earnestMoneyAmount” field within the “ContractDraft” state object. In some embodiments, the earnest money parser utilizes a specific regex anchored on the keyword “earnest,” such as “/(\d[\d,]*)\s*earnest/i”, to distinguish the deposit amount from other numeric sequences (e.g., a purchase price) within a compound natural language utterance. As illustrated, if a user states “5000 earnest,” the system first extracts the numeric value (“5000”) to the earnestMoneyAmount field. It then performs a conditional check to determine if the earnestMoneyHeldBy field is currently null in a State Dependency Check. In the State Dependency Check the engine performs a technical check to determine if the “earnestMoneyHeldBy” field is currently null. In some embodiments, the system may utilize a dependency mapping schema where the “earnestMoneyAmount” field is explicitly tagged with a “Requires-Holder” dependency; when the amount is non-null, the system may be programmatically forced to re-evaluate the “earnestMoneyHeldBy” state.

A Contextual Default Retrieval logic of some embodiments utilizes the “Persistence Layer” to retrieve a contextual default string (e.g., a “workspace company name”) from the active transaction metadata. In some embodiments, this may involve a Contextual Default Retrieval Protocol where the “Persistence Layer” executes a query against a “Metadata-Linked Retrieval Interface” (e.g., a Brokerage Profile Table) to retrieve a value linked to the active “user_id”. In further embodiments, the system may utilize proximity-based defaulting by analyzing the “Property Address” to select a default holder based on geographic proximity or local jurisdictional customs stored in a mapping table.

The system may incorporate an Auto-Suggestive Mutation protocol whereby the system populates a “pendingEarnestMoneyHeldBy” field with the retrieved default and sets the “awaitingConfirmation” flag to “earnestMoneyHolder”. In some embodiments, the “ContractDraft” object may implement an “onUpdate” listener such that when the “earnestMoneyAmount” is updated, a mutation protocol is triggered to automatically populate the “pending” field and set the “awaitingConfirmation” interrupt. In some embodiments, the system may implement a discrete intermediate state transition, such as “AWAITING_HOLDER_SUGGESTION,” which prevents the dynamic questionnaire engine from generating a generic inquiry and instead forces the generation of an auto-suggestive prompt.

This sequence triggers the dynamic questionnaire engine to generate a targeted verification prompt: “Is [Company Name] holding the earnest money?”. This proactive suggestion is a significant departure from prior art, as the system “mutates” the priority of a missing field based on the successful collection of a related field.

As further illustrated in FIG. 5, the system is configured to process the user's verification response. If the user provides an affirmative response (e.g., “yes”), the system accepts the suggested “Company Name” as the canonical “earnestMoneyHeldBy” value and clears the pending state. Conversely, if the user rejects the suggestion (e.g., “no” or “no, title company”), the system is programmatically forced to ask an open-ended follow-up: “Who will be holding the earnest money?”. Upon the user providing a specific response, such as “First American Title,” the engine accepts the input directly. In some embodiments, the system may utilize a Canonical Entity Mapping Table to resolve shorthand or informal responses (e.g., “HER Title”) to a formal legal entity name stored in the database.] The system may also implement a Conflict Detection Controller to suppress suggestions if keywords like “title company” or “attorney” are detected in the initial utterance.

Scenario B illustrates the integration of this flow within the Dynamic Questionnaire Engine and utilizing a trigger mechanism and/or sequential processing. For instance, the trigger mechanism would activate if the initial utterance lacked financial data, and the system would ask, “How much earnest money?”. With sequential processing, once the user provides a numeric response (e.g., “5000”), the system extracts the amount and immediately triggers the same auto-suggestion logic described in Scenario A. This ensures that the earnest money holder is verified through a streamlined “yes/no” confirmation rather than a more taxing open-ended query.

In “SCENARIO B,” the earnest money amount is not provided in the initial message and is instead requested via a dynamic questionnaire prompt: “How much earnest money?”. Once the user provides the numeric response (e.g., “5000”), the engine extracts the amount and immediately triggers the same auto-suggestion flow described in Scenario A.

In some embodiments, the system may implement a “default-suppression logic” acting as a “Conflict Detection Controller” where the auto-suggestion is bypassed if the system detects specific keywords in the initial input that conflict with the workspace default. In some embodiments, the system may utilize a negative keyword filter or “Conflict Detection Array” (including terms such as “title company,” “other,” “attorney,” or “buyer”); if any of these strings are detected within the same utterance as the amount, the auto-suggestive mutation may be programmatically disabled. In further embodiments, the system may utilize confidence-score gating where the auto-suggestion is suppressed if the surrounding text is determined to be ambiguous based on a calculated confidence threshold.

This state-aware logic represents a technical improvement in human-computer interaction by minimizing the “steps-to-completion” through predictive data population based on transactional context. As illustrated in FIG. 5, this workflow is predicated on the domain-specific insight that a specific party—often the listing brokerage associated with the user's workspace—typically holds earnest money in the majority of real estate transactions. By utilizing auto-suggestions for the common case while maintaining the ability to capture alternatives, the system minimizes the total number of required user utterances and reduces the likelihood of data entry errors associated with manual typing or complex dictation.

An Iterative Error Recovery Sequence as illustrated in FIG. 6A and FIG. 6B, which outlines the specific algorithmic logic used to ensure high data fidelity despite downstream platform validation failures. FIG. 6A and FIG. 6B illustrate the Iterative Error Recovery Sequence, specifically the execution of the patchDetailWithRetry( ) function. This sequence represents a critical technical solution to the problem of “brittleness” in third-party communication gateways, which includes API integrations, where a contract management platform may reject an entire data payload if even a single field is incompatible with that platform's specific template configuration. This sequence provides the ability to perform “graceful degradation” by programmatically identifying and pruning invalid fields while preserving and resubmitting all valid data.

Stated another way, FIGS. 6A and 6B provide a detailed view of an Iterative Error Mitigation Architecture, illustrating the logic of a “patchDetailWithRetry( )” function. In the illustrated embodiment, this algorithm enables graceful degradation when downstream platforms reject portions of submitted data. Unlike prior art systems, which typically fail entirely upon encountering any validation error, this system implements a platform-agnostic recovery mechanism that ensures maximum data persistence. This technical distinction is critical for maintaining high availability and reliability in a distributed architecture where downstream platform templates may vary or be updated independently of the core submission engine.

Thus, at a high level, the sequence begins with an attempt to synchronize the domain-specific ContractDraft data with a third-party contract platform. As shown in FIG. 6A, the system submits a structured payload containing multiple field categories, including “Property Address,” “Financials,” and “Contract Dates”. In this example, the payload includes an unsupported field, “Field X,” within the “Financials” section. Upon receiving a payload containing an incompatible field, the downstream platform returns a structured error message (e.g., a 400 Bad Request) indicating a VALIDATION_FAILURE. Some platforms provide a “pointer” (/Financials/attributes/Field X) that identifies the exact location of the invalid data. In prior art systems, such an error typically results in a total request failure, requiring manual user intervention to correct the data. This system's error recovery engine automatically parses an error message response to isolate the invalid fields. In some embodiments the engine maps the error pointers to an internal array, and then splits the pointer string to identify the specific “section” (“Financials”) and “attribute” (“Field X”) that caused the rejection. The engine then executes a delete command to remove only the invalid field from the local current payload, leaving the remaining valid fields intact. Following the pruning of invalid data, the system automatically initiates a resubmission of the modified payload, as shown in FIG. 6B via the “Retry Request,” which contains all original data from the “Property Address” and “Contract Dates” sections, but “Field X” has been removed from the “Financials” section. Because the incompatible field has been removed, the downstream platform can now process the remaining valid data and the system logs a successful update: “Details updated successfully (after retry)”. This iterative process may repeat up to a configured maximum number of retries to handle multiple validation errors. This ensures that the maximum amount of valid user data is saved to the contract platform despite variations in platform templates or API requirements, a capability not taught or suggested by general-purpose error handling systems. In one embodiment the maximum number of retries is six, while in further embodiments the maximum number of retries is reduced to five, four, or three. In another embodiment the maximum number of retries is at least two, three, or four.

As illustrated in FIG. 6A, the iterative error recovery sequence begins with an “INITIAL REQUEST” comprising a plurality of data objects, such as “Property Address,” “Financials,” and “Contract Dates.” In the illustrated embodiment, the “Financials” object may contain a specific “Field X” which is not supported by the downstream platform's current template. Upon submission, the system receives a “PLATFORM RESPONSE (Validation Error)” indicating a “VALIDATION_FAILURE.” Upon receiving a “PLATFORM RESPONSE (Validation Error)” with a 400 status, the system executes a Cross-Schema Mapping Interface to identify failure indicators. In one embodiment, the indicator is a URI-style pointer; in further embodiments, the indicator is selected from the group consisting of: a JSON path, a field-specific error code, or a localized string key. For example, the system may parse a pointer such as “/Financials/attributes/Field X” to programmatically identify the specific source of the failure. As shown in the illustrated embodiment, the error response includes a “pointer” attribute (e.g., “/Financials/attributes/Field X”) that programmatically identifies the specific source of the failure.

In one embodiment, to address this failure, the system executes a Cross-Schema Mapping Interface. In the illustrated embodiment, the system executes a “pointer-mapping” function to extract the path of the invalid field. In some embodiments, this functions as a “Downstream URI-to-Local Pointer Translation Layer” between heterogeneous data schemas, mapping URI-style pointers from a third-party platform to specific memory addresses or keys within the local state object. In some embodiments, the system then programmatically implements an Exclusionary Masking Protocol to remove only the identified invalid field (e.g., “delete current[section][attribute]”) while preserving all other valid data points within the transaction payload. This protocol functions as a structural data-cleansing step that allows the system to isolate the valid portions of the transaction data while suppressing only the specific field that triggered the validation failure.

Referring to FIG. 6B, in some embodiments the sequence continues with an Iterative Payload Pruning Sequence, resubmitting the payload with unsupported data points removed. This process may be managed by a “Heuristic Gating Controller” that may be configured to perform a maximum number of recursive retry passes, which in one embodiment is no more than 10, while further embodiments reduce it to no more than 8, 6, or 4. In the illustrated embodiment, the system resubmits the data payload, which now includes the valid “Property Address,” “Purchase Price,” and “Closing Date,” but with the previously identified “Field X” removed. In some embodiments, the system may resubmit the data through the “Heuristic Gating Controller” or abort the sequence if an “Error-Density Threshold” (e.g., greater than 50%, 60%, 70%, or 80% of the total payload) is met, thereby triggering a template re-validation event, or prompt the user for manual correction. This iterative approach allows the system to systematically “prune” unsupported data points until a “PLATFORM RESPONSE (Success)” is received.

As further illustrated in FIG. 6B, once a successful response is received, the system generates a success log (e.g., “Details updated successfully (after retry)”). In some embodiments, the system may implement a “Sync-Status Attribution Protocol” where every field in the state object is updated with a “State-Reconciliation Metadata Tag” (e.g., “SYNCED” or “PRUNED_REJECTED”) following the recovery sequence to reconcile the local state with the downstream platform's accepted data. In further embodiments, the system may utilize “Atomic Field-Level Decoupling” to divert pruned data to a “Local-Only Persistence Cache,” ensuring user data is preserved locally even if rejected by the “External API Template.”

This Iterative Error Mitigation Architecture represents a significant departure from prior art, which typically requires a complete manual correction and resubmission of the entire payload. By programmatically reconciling valid data against rigid downstream templates, the system ensures that valid information is saved and persisted despite variations or errors in specific field configurations. This protocol thus provides a technical solution to the problem of rigid validation requirements in heterogeneous software environments.

The sequence illustrated in FIG. 6A and FIG. 6B provides a significant technical advantage by automating the resolution of cross-platform data mismatches. By autonomously identifying and removing only the non-compliant portions of a transaction payload, the system maintains high data fidelity and operational continuity, effectively bridging the gap between informal natural language input and rigid structured database requirements.

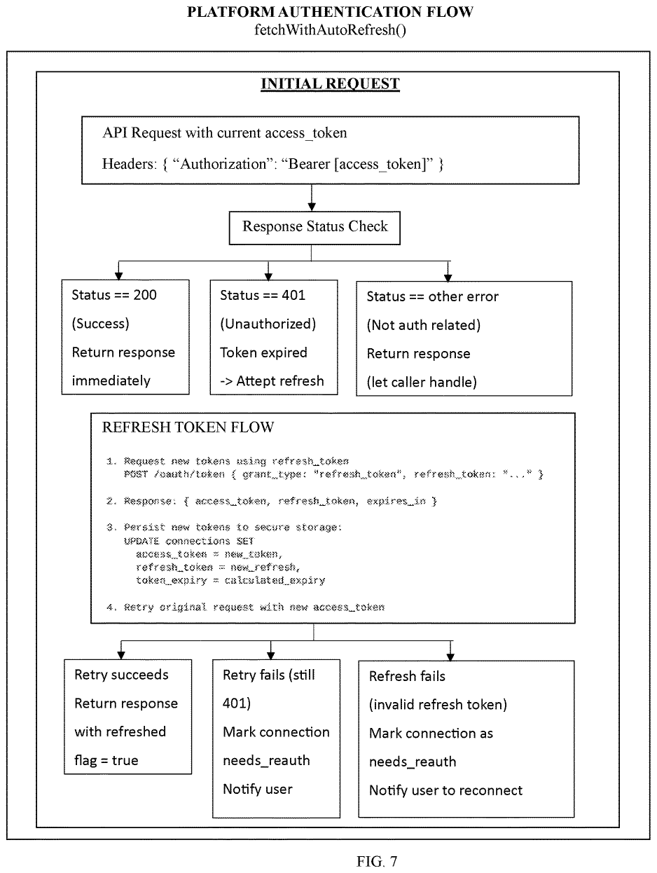

Referring to FIG. 7, a detailed view of a platform authentication flow is provided, specifically illustrating the logic of a “fetchWithAutoRefresho” function. This flow represents a critical infrastructure component of the system, enabling seamless and secure integration with external contract management platforms. The primary technical objective of this flow is to automate the management of OAuth-based authentication credentials, ensuring that transaction data synchronization is not interrupted by the expiration of short-lived access tokens. By implementing an automatic retry-on-expiry mechanism, the system maintains a transparent user experience while adhering to rigorous security standards.

In the illustrated embodiment, the primary purpose of this workflow is to manage the lifecycle of authentication credentials during communication with external contract platforms. Unlike prior art systems that may require application-level logic to handle expired session tokens, this system implements an Automated Authentication Middleware that is transparent to application logic. In some embodiments, this may be implemented via a structural Request-Response Interception Engine (e.g., a Higher-Order Function or Decorator) that wraps an underlying HTTP client to intercept response streams before they reach the contract drafting controller. By performing an automatic retry on expired tokens, the system ensures high availability of third-party integrations without complicating the high-level transactional code.

In one embodiment, the system implements the Iterative Error Mitigation Architecture, identified as the patchDetailWithRetry( ) sequence, to resolve data validation conflicts with third-party contract management platforms. Upon receiving a rejected data payload from an external API, the processor is configured to parse the returned error message for a machine-readable source pointer (e.g., a URI-style path such as/Financials/EarnestMoney/Amount) to isolate the specific data field causing the rejection. Rather than aborting the entire transaction, the system generates a dynamic Exclusionary Success-Probability Mask. This mask programmatically prunes the isolated non-compliant key-value pairs from the JSON payload while maintaining the structural integrity of all other validated data strings. The system then initiates a recursive resubmission of the pruned payload to the API. To prevent infinite processing loops during high-latency or high-error-density events, the processor utilizes a MAX_RETRIES constant (typically set between 3 and 6) and monitors an Error-Density Threshold. If the volume of invalid fields exceeds a predefined percentage (e.g., 80%) of the total payload, or if the retry limit is reached, the system terminates the recursive loop and triggers a state-machine interrupt to the Dynamic Questionnaire Engine, prompting the user for manual vocal clarification of the specific non-compliant fields.

As illustrated in FIG. 7, the process begins when the system initiates a communication with an external Universal Communication Gateway, such as an API, to perform a transaction-related task, such as creating a workspace or updating field details, utilizing a current access_token, which may be stored within the Persistence Layer. This token is typically passed via an “Authorization” header using the Bearer scheme. The process may begin with an “INITIAL REQUEST” where a Communication Gateway request is initiated utilizing a current “access_token” within the authorization headers. Following the request, the system executes a “Response Status Check” to evaluate the return state of the platform:
1. Success State (Status==200): If the token is valid and the request is processed, the system returns the response immediately to the calling function.
2. Unauthorized State (Status==401): If the platform indicates the token has expired, the system automatically triggers a “REFRESH TOKEN FLOW” configured to manage at least one Transient Access Credential. One embodiment manages a bearer token; further embodiments manage at least two artifacts selected from: refresh tokens, session cookies, cryptographic certificates, or API keys.
3. Other Error States: For non-authentication-related errors (e.g., 404 or 500), the system returns the response and allows the standard application error-handling logic to manage the outcome.

When a 401 error is detected, the system shifts into a proactive recovery mode to obtain fresh credentials. The system sends a POST request to the platform's OAuth token endpoint (/oauth/token) using a stored refresh_token to request new tokens. The platform may return a new payload containing a fresh access_token, a new refresh_token, and an expiration duration (expires_in). The system updates the encrypted connection records in the Persistence Layer, calculating a new token expiry timestamp to govern future refresh cycles. Armed with a new access token, the system automatically retries the original Gateway Communication request without requiring the user to re-initiate the command. As illustrated at the base of FIG. 7, the retry attempt results in one of three final states:
Retry Succeeds: The system returns the successful response to the user, typically with an internal “refreshed” flag set to true for logging purposes.
Retry Fails (Still 401): If a fresh token still results in an unauthorized error, it indicates a critical synchronization issue. The system marks the connection record as needs_reauth and notifies the user.
Refresh Fails: If the refresh_token itself is invalid or has been revoked, the refresh flow terminates. The system similarly marks the connection for re-authorization and prompts the user to reconnect their account.

In the illustrated embodiment of the “REFRESH TOKEN FLOW,” the system executes a multi-step credential recovery sequence:
1. Token Refresh Request: The system requests new tokens using a stored “refresh_token” via a POST request to the platform's OAuth endpoint.
2. Credential Persistence: Upon receipt of a new “access_token” and “refresh_token,” the system initiates a Secure Storage Persistence Protocol via a Transactional Credential Update Module that ensures an atomic database transaction. In some embodiments, the system persists refreshed tokens for subsequent requests by executing an “UPDATE” command on a secure “connections” table. In some embodiments, this persistence may be managed by a Transactional Credential Update Module that ensures an atomic database transaction where new credentials are verified before the active session is updated. In some embodiments, the system may further implement a “Header-Injection Interface” or “Credential Injection Pipeline” that automatically refreshes an in-memory cache of the active session, ensuring subsequent requests utilize the new credentials without manual intervention.
3. Original Request Retry: Following successful persistence, the system automatically retries the original request. In some embodiments, the system may implement an Atomic Authentication Lock or a Token-Refresh Semaphore for a specific user ID to prevent concurrent drafting tasks from initiating redundant refresh cycles simultaneously, thereby resolving network race conditions.

As further illustrated in FIG. 7, the system may implement a Circular-Execution Guard to ensure system stability. In some embodiments, the system is configured to perform a single refresh attempt per request to prevent infinite loops. In some embodiments, the “fetchWithAutoRefresh( )” function may implement a structural Recursive-Depth Gate or accept a “Transient Request Metadata” tag (e.g., an “isRetry” flag) to enforce a hard-coded termination threshold. If the “Retry fails (still 401)” or if the “Refresh fails,” the system executes a Connection Invalidated Protocol. In some embodiments, the system may implement a “Cross-Process Context Preservation” logic where the specific transactional state is suspended in a “Request Buffer” during the refresh flow and “thawed” only after successful re-authentication. In further embodiments, the system may function as a Lease-Based Session Manager where the connection is programmatically invalidated if a valid lease cannot be established via the refresh flow.

This “fetchWithAutoRefresh( )” logic represents a significant departure from prior art by decoupling the complexities of session management from the transactional drafting logic. By programmatically reconciling token expiration at the infrastructure layer, the system ensures that the “Iterative Error Mitigation Architecture” described in FIGS. 6A and 6B can operate across a stable and authenticated connection.

The flow illustrated in FIG. 7 provides several key advantages over prior art:
Transparency: The entire refresh and retry sequence is transparent to the primary application logic, preventing failures in high-level tasks like patchDetailWithRetry( ).
Loop Prevention: The system is configured to perform only a single refresh attempt per request, preventing infinite loops in the event of persistent platform-side issues.
Efficiency: By persisting refreshed tokens immediately, the system ensures that subsequent requests utilize valid credentials, minimizing the latency associated with repeated 401 errors.

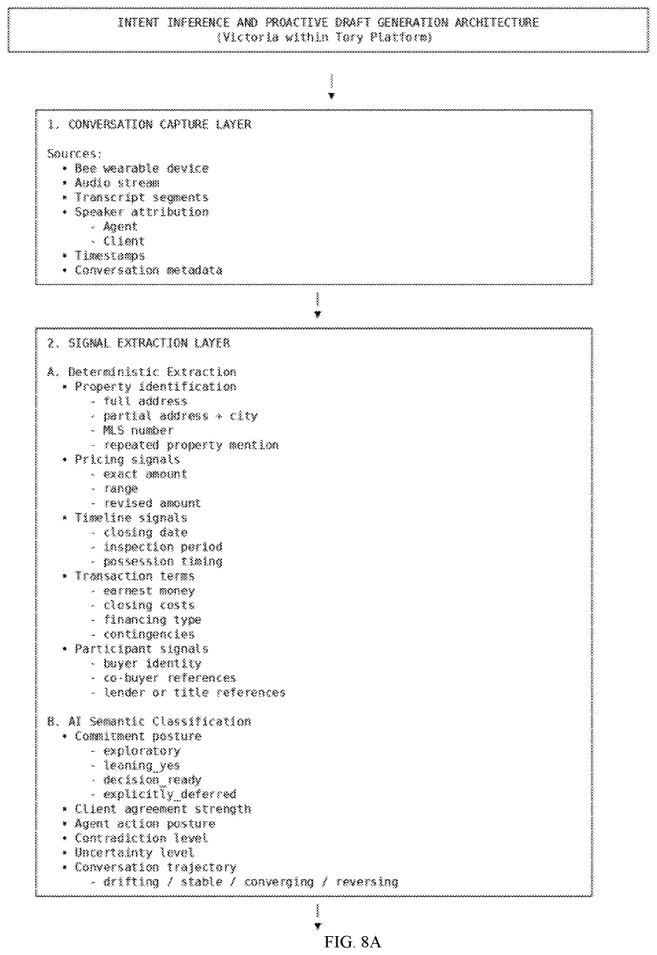

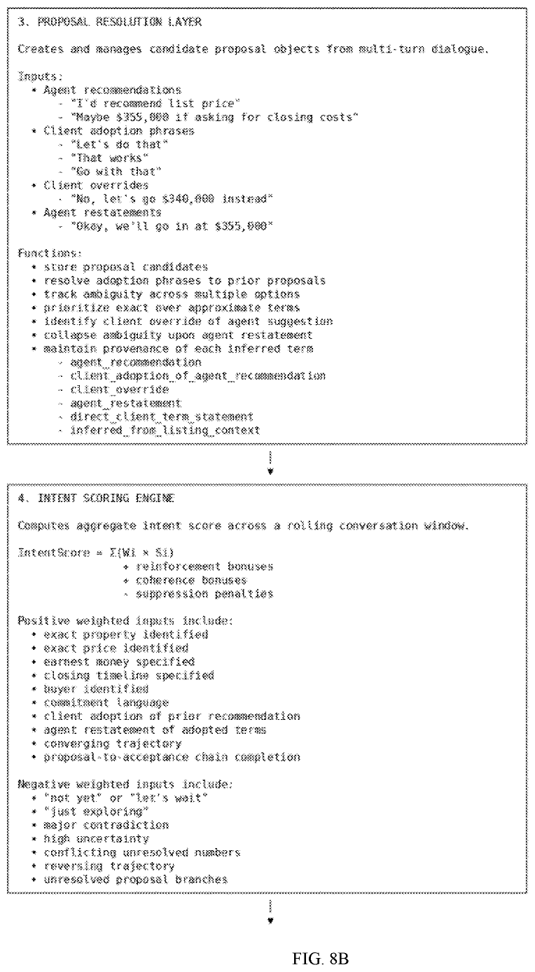

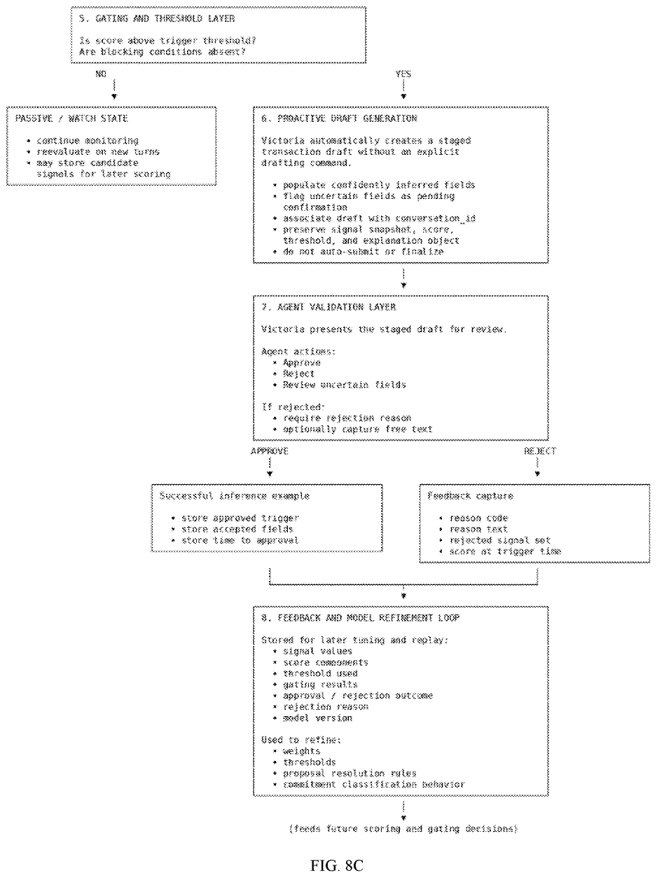

In a further embodiment the system is proactive rather than reactive. An Intent Inference and Proactive Draft Generation Architecture embodiment is illustrated in FIGS. 8A-8C and may incorporate any of the prior disclosure. It incorporates a structured, multi-layer decision framework that transitions from passive monitoring to proactive transaction execution. Thus, FIG. 8 illustrates an embodiment where the system that does not merely respond to explicit commands but instead applies a structured, multi-layer decision framework to determine when conversational data has transitioned into actionable transactional intent. This transition is governed by evaluating multiple categories of signals across a multi-speaker conversation rather than detecting a single keyword or instruction. The system distinguishes between a passive conversational state, where it monitors dialogue, and an actionable transactional intent state, where it prepares to initiate a drafting workflow.

As seen in FIG. 8, the process initiates at a Conversation Capture Layer, which serves as the ingestion point for raw conversational data. The system receives conversation data from a capture source such as a Bee device or another audio-enabled input channel. The input may include audio, transcript segments, timestamps, metadata, and speaker attribution identifying whether a particular utterance came from the agent or the client. The system aggregates input from various sources, including wearable devices (e.g., Bee bracelet/wrist devices, glasses, apparel, etc.), implantable devices, which will also be referred to as wearable devices or wearables, live audio streams, and pre-processed transcript segments. The present category relates to wearable, context-aware computing devices configured to sense and record ambient information and to generate summaries, reminders, or other inferred outputs based on the sensed information. The devices may be lightweight, having a screen/display or may be screenless, and designed for passive operation throughout daily use. Data may be stored locally, transmitted to a paired mobile device or a stationary device, or processed by remote services to support search, recall, and assistant-like functions. The input source includes a microphone or equivalent sensor for auditorily sensing the environment near the user. The input source may be capable of connecting with a companion device for exchanging data and/or sharing resources. The companion device may be any electronic device, such as a personal computer, a laptop, a tablet, a smartphone, a personal digital assistant (PDA), a camera, a virtual reality headset, an Internet of things (IoT) device, a vehicle (e.g., a car, a motorcycle, a bicycle, a scooter, etc.), an appliance, a television, a wearable such as a watch or glasses, etc. In addition to raw text, the layer may identify contextual metadata such as speaker attribution (distinguishing between Agent and Client roles), timestamps, and specific conversation IDs to maintain context-aware processing.

Next, a Signal Extraction Layer may process transcripts to extract deterministic transactional signals and/or AI-derived semantic signals. The system performs two categories of extraction. First, deterministic extraction identifies structured transactional elements such as property references, prices, dates, participants, earnest money, closing costs, financing type, or other transaction terms. Second, AI semantic classification analyzes the same conversation data to produce structured semantic outputs including commitment posture, agreement strength, contradiction level, uncertainty level, and overall conversation trajectory. In some embodiments these outputs are structured inputs to downstream scoring logic and are not themselves final action triggers. Thus, a Deterministic Extraction module identifies structured elements including property identification (addresses, MLS numbers), pricing signals, timeline signals, transaction terms, and participant signals, as itemized in FIG. 8. An AI Semantic Classification system evaluates qualitative signals such as commitment posture (e.g., “leaning yes” vs. “decision ready”), client agreement strength, agent action posture, and conversation trajectory (determining if the dialogue is drifting, stable, or converging). Thus, in one embodiment the system comprises a signal extraction layer incorporating a deterministic signal extraction module to identify at least one qualitative signal from the group of qualitative signals comprising commitment posture (e.g., “leaning yes” vs. “decision ready”), client agreement strength, agent action posture, and conversation trajectory; while further embodiments identify at least two, three, four, or five of the qualitative signals. Thus, a further embodiment the system comprises an AI semanic classification system to evaluate at least one qualitative signal from the group of commitment posture, client agreement strength, agent action posture, contradiction level, uncertainty level, and conversation trajectory; while further embodiments evaluate at least two, three, four, or five of the qualitative signals.

The Intent Inference and Proactive Draft Generation Architecture embodiment may further include a Proposal Resolution Layer having a Proposal Resolution Module, which explicitly models a proposal-to-acceptance-to-confirmation pattern across multiple turns. This layer is central to the invention because real estate transaction intent is often formed across multiple turns rather than through a single explicit instruction. The layer creates candidate proposal objects from agent recommendations, such as suggested prices or closing cost strategies. It then resolves client adoption phrases such as “let's do that” or “that works” against previously proposed terms within the same property cluster and conversation window. It also handles client overrides, restated terms, ambiguity among multiple proposal paths, and provenance tracking for each inferred term. The module may perform one or more of the following:
Proposal Extraction: When an agent proposes terms (e.g., “I'd recommend List price”), the system creates candidate Proposal Objects, which may also be referred to as a Proposal Candidate.
Adoption and Override: The system detects adoption phrases such as “Let's do that” or “That works” and resolves them against the most recent coherent proposal set. If a client introduces a different value (an override), that value is treated as a higher-authority signal.
Restatement Confirmation: If an agent restates terms after client acceptance (e.g., “Okay, we'll go in at $355 k”), it is treated as a high-confidence confirmation event that resolves remaining ambiguity. One embodiment requires a restatement confirmation before proceeding.

The Intent Inference and Proactive Draft Generation Architecture embodiment may further include an Intent Scoring Engine, seen in FIG. 8B, to compute an aggregate intent score using a weighted, multi-signal model. The intent scoring engine computes an aggregate intent score by combining a plurality of weighted positive signals, weighted negative signals, reinforcement bonuses, coherence bonuses, and suppression penalties across a rolling conversation window. One embodiment requires at least weighted positive signals and weighted negative signals, while a further embodiment also requires at least one of the reinforcement bonuses, the coherence bonuses, and the suppression penalties; while a further embodiment requires at least two of the reinforcement bonuses, the coherence bonuses, and the suppression penalties; and yet another embodiment requires the reinforcement bonuses, the coherence bonuses, and the suppression penalties.

This allows the system to distinguish casual or exploratory discussion from actionable transactional intent.
Weighted Model: The score is conceptually calculated as
   IntentScore=Σ(Wi×Si)+reinforcement bonuses+coherence bonuses−suppression penalties, also as:
   $IntentScore=\Sigma (W_i\times S_i)+bonuses−penalties$.
Scoring Factors: Scoring is driven by property, pricing, and timeline specificity, as well as proposal adoption and restatement events.
Suppression Penalties: Negative weighting is applied for exploratory posture, explicit deferral language, or unresolved contradictions.

Si (The Signal): Si represents the presence and strength of a specific conversational signal. In one embodiment these signals are extracted from both Deterministic Extraction (e.g., specific property addresses, exact prices, or dates) and AI Semantic Classification (e.g., the level of commitment posture or conversation trajectory). Example signals include property specificity, pricing specificity, timeline specificity, and participant identification. Wi (The Weight): Wi represents the relative weight assigned to each specific signal category. In one embodiment the weighting is not fixed; it is adaptive and can be recalibrated over time based on validation feedback from agents (e.g., if a draft was generated too early or for the wrong reason). Weights can also vary depending on the specific workspace or the type of transaction being discussed. However, in another embodiment the weighting is fixed, while in another embodiment it is adjustable, while in a further embodiment it is only adjustable by an administrator.

Positive weighted inputs include exact property identification, an exact price, specified earnest money, a defined closing timeline, identified buyers, commitment language, client adoption of a prior recommendation, agent restatement of adopted terms, a converging trajectory, and completion of the proposal-to-acceptance chain. In one embodiment the weight Wi of a positive weighted input is greater than 0.5, while in further embodiments it is increased to at least 0.6, 0.7, or 0.8. Negative weighted inputs include statements such as “not yet” or “let's wait,” indications that the party is “just exploring,” major contradictions, high uncertainty, conflicting unresolved numbers, a reversing trajectory, and unresolved proposal branches. In one embodiment the weight Wi of a negative weighted input is less than 0.5, while in further embodiments it is no more than 0.45 or 0.40.

Reinforcement bonuses are applied when a specific intent or transaction signal is sustained or repeated over time. Multi-Turn Presence: In this embodiment the system tracks signals across a rolling conversation window rather than a single utterance. If a signal (like a specific price) is reinforced across multiple turns, a bonus is applied to reflect higher confidence. Restatement Confirmation: Additionally, a significant reinforcement bonus is triggered when an agent restates transaction terms after a client has accepted them (e.g., Agent: “Okay, we'll go in at $355 k”). This act of restating is treated as a high-confidence confirmation event that resolves remaining ambiguity.

Coherence bonuses are applied when independent data points or signals logically align to support a single transaction intent. Signal Alignment: In one embodiment the system evaluates the logical consistency between different categories of extracted data. For example, if a specific property address is mentioned alongside a specific price and a specific timeline, the “coherence” between these independent signals triggers a bonus. Proposal-to-Acceptance Logic: When a client's adoption phrase (e.g., “Let's do that”) can be clearly resolved against a prior agent proposal (e.g., “I'd recommend the list price”), the resulting coherence between the proposal and the acceptance reinforces the intent score. Trajectory Stability: A coherence bonus may be applied if the conversation trajectory is classified as “stable” or “converging,” indicating that the participants are consistently moving toward a final agreement rather than drifting or reversing. These bonuses are critical because they allow the system to reach the execution threshold required for proactive draft generation without needing an explicit command from the user.

Suppression penalties are negative weighting factors applied to the IntentScore to reduce the likelihood of the system initiating a proactive action. These penalties act as a mathematical “brake” within the scoring model to ensure that a draft is not generated when the conversation is too ambiguous, exploratory, or explicitly non-transactional. Specific categories of suppression penalties include:
Explicit Deferral Language: Penalties are applied if participants use phrases that indicate they are not ready to act, such as “let's talk next week” or “I need to think about it”.
Exploratory or Advisory Posture: If the AI semantic classification determines the conversation is merely exploratory or advisory rather than execution-ready, a negative weight is applied to the score.
High Uncertainty or Contradiction: The system penalizes the score if it detects significant unresolved contradictions between speakers or high levels of uncertainty regarding the terms.
Conflicting Terms: If transaction terms are introduced that conflict with prior established data without being resolved, a suppression penalty is applied to maintain data integrity.
Non-Actionable Domains: While not a direct penalty to the score itself, the system applies a “hard-stop” penalty to the Action Gating layer if the interaction is classified into a non-transactional domain, such as coaching or recruiting, regardless of how high the intent score might be.
Lack of Specificity: The absence of an identifiable property or key financial terms serves as a primary driver for score suppression, as these are considered “hard-stop” conditions for proactive drafting.

In one embodiment the Intent Scoring Engine specifically examines the audio for at least 2, 3, 4, or 5 of the suppression penalties selected from explicit deferral language, exploratory or advisory posture, high uncertainty or contradiction, conflicting terms, non-actionable domains, and lack of specificity.

In some embodiments, to prevent “false positives” in a real-time voice environment, the processor applies numerical adjustments to the aggregate sum. For example a positive Multi-Turn Stability Bonus may be applied by the system as a reinforcement constant if the same semantic value is extracted from the data stream across three or more consecutive processing windows. This indicates a “converged” data point that is ready for validation. In one embodiment the positive Multi-Turn Stability Bonus is at least 0.1 or 0.15. Similarly, a negative Vague Deferral Penalty may be applied by the system as a negative suppression constant if the natural language engine detects “deferral markers” (e.g., “I'm not sure,” “maybe,” “TBD”). This penalty forces the IntentScore below the required threshold, automatically triggering the Dynamic Questionnaire Engine to ask a follow-up “re-entry” question. In one embodiment the negative Vague Deferral Penalty is less the −0.10, −0.15, or −0.20.

The system may employ a Risk-Adjusted Acceptance Thresholds whereby the system does not utilize a global threshold; instead, it utilizes a Mutual Exclusion Mapping Table to vary the required IntentScore based on the legal significance of the field. For example, the Financial and Legal Fields, such as EarnestMoneyAmount or ClosingDate, require a minimum threshold A for automatic acceptance; While, the Administrative Fields, such as AgentLicenseNumber or MailingAddress, utilize a relaxed threshold of threshold B, which is less than threshold A. In one embodiment threashold B is at least 5%, 10%, or 15% less than threshold A. In another embodiment threashold B is at least 40%, 50%, or 60% of threshold A. In one embodiment threshold A is 0.85-0.95 and threshold B is 0.60-0.80.

The Intent Inference and Proactive Draft Generation Architecture embodiment may further include a Gating and Threshold Evaluation, as seen in FIG. 8C. The system applies threshold-based and/or context-aware gating to determine whether an automated action is permitted. The system evaluates whether the computed score exceeds one or more thresholds and whether hard-stop or soft-stop conditions are present. If the threshold is not met, or if blocking conditions exist, the system remains in a passive or watch state. In one embodiment an Action Gating module ensures drafting occurs only when the aggregate intent score exceeds a defined execution threshold intent score and no “hard-stop” conditions (e.g., absence of an identifiable property) are present. In another embodiment a Domain Classification model classifies the interactions into operational domains, such as Transaction Execution or Coaching. Even if similar conversational patterns appear, the system suppresses transaction drafting in a coaching context, instead enabling alternative actions like task creation or summaries.

The trigger threshold score is a critical component, serving as the quantitative “tipping point” that determines when the system transitions from passive monitoring to proactive transaction execution. It ensures that automated actions, such as drafting a contract, occur only when there is high mathematical confidence in the user's intent. Based on the system architecture, a detailed breakdown of how this threshold functions includes some, or all, of the following:

Threshold Classification States. The system categorizes the aggregate IntentScore into specific actionability ranges. When a below trigger threshold score is present, the system remains in a passive or monitoring state, continuing to aggregate signals without initiating workflows. When an intermediate range threshold score is present, the system enters a watch state, where it may increase the frequency of signal evaluation as the conversation nears a potential trigger point. When an above trigger threshold score is present, the conversation is identified as a candidate for action. When an execution threshold score is present (aka a Proactive Trigger) when the score exceeds the above trigger threshold score and no “hard-stop” blockers are present, the system proactively triggers the generation of a transaction draft.

In some embodiments crossing a numeric threshold alone is insufficient for execution; the system requires a stable context to proceed, and thus may have mandatory conditions for triggering. One such mandatory condition may be that the system must have resolved a specific property address or MLS reference. Another mandatory condition may be a commitment/adoption signal, which means at least one explicit commitment (e.g., “decision ready”) or adoption signal (e.g., “let's do that”) must be present in the signal mix. A mandatory condition may be trajectory stability, meaning that the conversation trajectory must further be classified as stable or converging; and in a further embodiment a “reversing” trajectory will prevent a trigger even if the score is high.

The value of the trigger threshold score need not be a static number, in fact in some embodiments is an adaptive variable. One such situation examines domain-based variation, meaning the threshold score may differ depending on the transaction type (e.g., a purchase offer may require a higher confidence score than a rental listing). The system may further include feedback recalibration whereby if an agent rejects a proactively generated draft with the reason code “acted_too_early,” the system uses that feedback to automatically increase the threshold value for that specific context. Further, the system may incorporate workspace tuning whereby the threshold score can be adjusted at the workspace or team level to match the specific conversational style or risk tolerance of different agent groups. Additionally, the system may include hard-stop overrides whereby even if the IntentScore far exceeds the trigger threshold, certain “Hard-Stop” conditions act as an absolute block on proactive execution. One such hard-stop condition may be explicit deferral phrases like “let's talk next week” apply immediate suppression; while another may include unresolved contradictions characterized by major conflicting terms (e.g., two different prices discussed without resolution) will halt the trigger; and another may include detection of the presence of hypothetical contexts, meaning if the AI Semantic Classification identifies the dialogue as purely hypothetical or for coaching purposes, the execution is suppressed regardless of the score.

The Intent Inference and Proactive Draft Generation Architecture embodiment may further include a Proactive Draft Generation stage, as seen in FIG. 8C. When threshold and domain conditions are satisfied, the system proactively generates a structured transaction draft without requiring an explicit command. This draft compiles all resolved terms and associates them with the source conversation and the specific signals that triggered the action. Thus, if the threshold conditions are satisfied and blocking conditions are absent, the system proactively generates a staged transaction draft without requiring an explicit command such as “write the offer.” The draft includes confidently inferred fields, identifies unresolved fields as pending confirmation, and stores the explanation snapshot that caused the draft to be created. Confidently inferred fields are quantified through a weighted, multi-signal scoring model that aggregates both deterministic data and semantic qualitative signals, as previously disclosed. The explanation snapshot is a component of the system's transparency and refinement logic, specifically designed to capture a detailed “moment-in-time” record of the variables that led to a proactive drafting action. It serves as a diagnostic tool that bridges the gap between the system's automated decisions and the agent's human validation. Based on the system architecture, the explanation snapshot may include any, or all, of the following elements:
Extracted Signals: A record of all deterministic transactional signals (e.g., property addresses, prices, and dates) and AI-derived semantic signals (e.g., commitment posture and trajectory) identified in the conversation.
Computed Intent Score: The aggregate mathematical value derived from the weighted signal model ($\sum W_i\times S_i$) at the exact moment the threshold was crossed.
Threshold and Gating Context: The specific execution threshold and context-aware domain gating rules that were in effect at the time of the action.
Proposal Resolution State: The map of candidate proposals and adoption events that resolved multiple speaker turns into a coherent set of terms.
Source Attribution: A direct association between the generated draft and the specific segment of the source conversation that triggered it.

The snapshot is used in two primary ways within the Post-Action Validation and Structured Feedback loop:
1. Agent Review: It provides the agent with an explanation of why a draft was prepared, allowing them to verify the system's reasoning before approving or rejecting the work.
2. System Refinement: If a draft is rejected (e.g., for being “too early” or having an “incorrect price inference”), the snapshot is used alongside the agent's feedback to recalibrate signal weights ($W_i$), threshold values, and proposal resolution rules.

This mechanism ensures the system functions as a closed-loop architecture, where every proactive action—whether successful or rejected—contributes to the continuous refinement of future intent determinations.

The Intent Inference and Proactive Draft Generation Architecture embodiment may further include an Agent Validation and System Refinement layer, as seen in FIG. 8C. This stage involves a human-in-the-loop feedback loop to refine the system's decision-making logic. The staged draft is presented to the agent for review. The agent may approve the draft or reject it. This stage ensures that the system's autonomous inferences are verified by a human expert before any formal legal workflow is finalized.

If the draft is rejected, the system may be configured to require a rejection reason and may optionally collect freeform explanatory feedback. The system may store, for a predetermined (and in some embodiments adjustable) period of time, the extracted signals, score components, threshold values, gating results, approval or rejection outcomes, and/or rejection reasons. These stored examples may then be used to tune future weights, thresholds, and proposal resolution rules, thereby refining future intent determinations. The agent reviews the draft and provides structured feedback, including rejection reason codes such as “acted_too_early,” “incorrect_price_inference,” or “hypothetical_discussion”. All outcomes, including extracted signals, computed scores, and validation results, may be stored and used to recalibrate signal weighting and threshold values for future intent determinations.

When an agent reviews a proactively generated draft and determines it accurately reflects the client's intent and the transaction terms, the agent may issue an approval. Upon approval, the staged draft is promoted to an active transaction record within the downstream contract management platform. The system may record this successful outcome, treating the specific combination of signals (e.g., high specificity in property, price, and commitment posture) as a “positive example” for the intent model. Successive approvals for similar conversational patterns reinforce the existing signal weights ($W_i$) and threshold values, confirming that the current model parameters are effectively identifying actionable intent.

If a draft is rejected, the system is configured to capture structured feedback to prevent future false positives. The system may require the agent to select from a set of predefined rejection reason codes. These may include:
“acted_too_early”: indicating the intent score crossed the threshold prematurely during an exploratory phase.
“incorrect_price_inference”: signifying an error in the Proposal Resolution Layer or price parsing.
“hypothetical_discussion”: notifies the system that the AI Semantic Classification failed to distinguish between a coaching/educational scenario and a real-world transaction.

Freeform Feedback: Optionally, the system may collect freeform explanatory feedback to provide nuanced context that structured codes may miss.

Regardless of the outcome (approval or rejection), the system stores a comprehensive record of the event for a predetermined, and in some embodiments adjustable, period of time. Data Points Stored: The system persists the explanation snapshot, which includes the exact extracted signals, computed score components, threshold values at the time of action, gating results, and the final approval or rejection outcome.

The stored outcomes are utilized by a Model Refinement and Replay Module to tune the system's decision-making logic. The system uses rejection data to recalibrate signal weighting ($W_i$) and execution thresholds. For instance, a rejection for “acting too early” may result in a mathematical increase in the required trigger threshold for similar future contexts. This continuous refinement process ensures that the system evolves to match the specific conversational style and risk tolerance of different users or workspaces, progressively reducing false-positive draft generation while maintaining proactive utility.

In an embodiment the input data source comprises an artificial intelligence assisted wearable system including a wearable, a companion device (e.g., a laptop), and/or one or more servers. The companion device and/or the server may be any type of electronic device capable of performing their respective functions described above, consistent with the present concepts. The companion device and the server may even be included in the same device. The server may include a server computer, a personal computer, a laptop, a video game console, a tablet, a smartphone, or any computer device having storage resources and processing resources. The number of devices and the client-versus-server type of the devices described and depicted are intended to be illustrative and non-limiting.

The wearable, the companion device, and/or the server may be connected (via wire or wirelessly) to one or more networks to communicate with another network and/or access the Internet. One input source configuration comprises an operating system (OS) centric configuration. A second input source configuration comprises a system on a chip (SoC) configuration. The operating system centric configuration can be organized into one or more applications, an operating system, and hardware. The second configuration may be organized into shared resources, dedicated resources, and an interface therebetween. In either the first configuration or the second configuration, the server can include a storage and a processor. The server can also include an artificial intelligence engine. In the second configuration, the functionality provided by the server can be integrated on a single SoC or multiple coupled SoCs. The processor can be configured to coordinate with the shared resources, such as the storage, etc., and/or the dedicated resources, such as the artificial intelligence engine configured to perform certain specific functionality. Thus, the term “processor” as used herein can also refer to central processing units (CPUs), graphical processing units (GPUs), controllers, microcontrollers, processor cores, or other types of processing devices. The term “device,” “computer,” or “computing device” as used herein can mean any type of device that has some amount of processing capability and/or storage capability. Processing capability can be provided by one or more hardware processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, optical storage devices (e.g., CDs, DVDs etc.), and/or remote storage (e.g., cloud-based storage), among others. As used herein, the term “computer-readable media” can include transitory propagating signals. In contrast, the term “computer-readable storage media” excludes transitory propagating signals. Computer-readable storage media may include computer-readable storage devices. Examples of computer-readable storage devices may include volatile storage media, such as random-access memory (RAM), and non-volatile storage media, such as hard drives, optical discs, and flash memory, among others.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

As mentioned above, the artificial intelligence engine may include one or more modules for performing a certain related set of computerized tasks. For example, the artificial intelligence engine may include a voice recognition module. When the user talks, the wearable picks up the audio, and the voice recognition module may receive a recording of the user's speech and use artificial intelligence to recognize the voice of the user, as distinguished from the voices of other people, for identification and/or authentication purposes. For instance, the input source may include a security feature that allows it to be used only by the user or only by a certain set of authorized users. The input device may be trained to recognize the voice of the user, for example, when the user first uses or registers to use the device. The artificial intelligence engine may include a speech recognition module for interpreting the voice commands provided by the user. For example, the speech recognition module may convert the audio recording of the voice command from the user into text using artificial intelligence. The speech recognition module may be generically trained using speech from a large population and/or specifically trained using speech from the user.

The artificial intelligence engine may include a cognitive module for interpreting and understanding the semantics, logic, reason, and/or purpose of the voice commands provided by the user. The cognitive module may use a combination of rules and machine learning to decipher voice commands, for example, to determine one or more tasks to be performed in response to the voice commands.

Consistent with the present concepts, the user may provide a contextual voice command that includes a contextual signal relating to any contextual information (e.g., an object) in the environment surrounding the user. For example, a contextual signal may be any non-explicit reference (e.g., a contextual reference or a contextual cue), including pronouns (e.g., “this,” “that,” “it,” “him,” “her,” “what,” “who,” “these,” “both,” etc.), as well as other indirect references (e.g., “here,” “one,” “some,” etc.). The cognitive module may recognize that the voice command is contextual and may determine the proper context using one or more input components to sense the environment and then interpreting the environment using one or more of the modules in the artificial intelligence engine. These techniques will be described in more detail below with reference to later figures. The artificial intelligence engine may include a digital assistant module for performing computerized tasks (e.g., consisting of computerized actions) for the benefit of the user. For example, the digital assistant module may perform a task that the cognitive module determined should be performed in response to a voice command from the user. The digital assistant module may have access to information, such as a digital calendar of the user, a digital address book of the user, a digital shopping list of the user, a digital task list of the user, the Internet, encyclopedias, search engines, databases of songs, databases of images, databases of maps, databases of business directories, current and historical weather data, etc. The digital assistant module may perform any computerized task so long as it has access to read and/or write the required data for the task. Example of tasks that the digital assistant module can perform may include adding events to the user's calendar, reminding the user about an incomplete task in his task list, answering a question from the user by accessing one or more data sources, sending a text message, reading an email, etc.

The digital assistant module may generate outputs to the user. The outputs may be a vocal answer to a question from the user, an acknowledgment of a command from the user, a feedback that a task was performed, a request for information from the user, etc. The output may be an auditory output produced by a speaker, a visual output produced by a display, and/or a haptic output produced by a haptic component. Other types of outputs are possible.

In one implementation, the wearable may include a network interface to connect to one or more networks and to communication with other devices (e.g., the companion device, the server, or any other device). For example, the wearable may include a wired network interface (e.g., an Ethernet interface) and/or a wireless network interface (e.g., a cellular network interface, a Wi-Fi network interface, a Bluetooth network interface, and/or a near field communication (NFC) interface). The cellular network interface may use a subscriber identity module (SIM) card and enable the wearable to access the Internet through a cellular data network when the user is anywhere within a cellular network coverage area.

In one implementation, the wearable may use the network interface to access data (including computer programs) that is stored remotely. For example, the user's calendar, address book, task list, and/or shopping list may be stored in a remote server (e.g., a cloud storage), that is accessible via the Internet. The wearable may also access other remote data sources (e.g., encyclopedias, search services, databases, etc.) using the network interface. In some implementations, the artificial intelligence engine (or certain modules thereof) may be located in a remote server. These implementations may be more feasible and appropriate where the artificial intelligence engine (or certain module thereof) requires more processing power, storage, and/or other resources than can fit in the wearable.

In some implementations consistent with the present concepts, the wearable may operate in an offline mode. For example, the wearable may operate in offline mode without using any of its network interfaces and thus without connecting to a network or communicating with other devices. The wearable in the offline mode may have limited capabilities that do not require communicating with any other devices (including the servers).

Consistent with the present concepts, the wearable may utilize resources available on the companion device and/or the servers to provide digital assistance experience for the user. For example, in one implementation, the wearable may connect to the Internet using the companion device's cellular network connection in order to use the artificial intelligence engine available on the server. In another implementation, wearable may use a GPS unit of the companion device to determine the location of the user rather than having its own built-in GPS. In another implementation, the wearable may use a speaker on the companion device to output auditory feedback to the user instead of having or using its own built-in speaker.

The artificial intelligence engine may use a cognitive module to interpret and understand a contextual voice command provided by the user. In some implementations, the cognitive module may include natural language processing capabilities as well as human-computer interaction reasoning functionalities. Accordingly, the cognitive module can detect any contextual signals that refer to the user's environment and interpret contextual voice commands. The cognitive module may use other modules (e.g., the audio recognition module) to perceive the environment. The cognitive module can also decide what computerized task should be performed in response to the voice command. In one implementation, the cognitive module can use the digital assistant module to carry out the computerized task. The cognitive module may be implemented based on defined rules and/or machine learning. Furthermore, the cognitive module may be continuously modified, for example, continuously learning based the behavior of the user.

The configurations disclosed herein, including the Sliding-Window Buffer Controller, the Context-Aware Recursive Decoder, and the Reactive Stream Regulator, provide a technical solution for maintaining semantic integrity across non-persistent data streams. In the Sliding-Window Buffer Controller embodiment, enablement is provided by a Buffer Handover Protocol configured to monitor a Fill-Level Threshold (e.g., 80%, 70%, 60%, or 50% capacity) of a Primary Processing Buffer; upon the transcription service consuming a data segment, the controller is programmatically forced to execute a Memory-Pointer Swap that shifts the contents of a Secondary Pre-Fetch Buffer into the primary processing stream. In the Context-Aware Recursive Decoder embodiment, semantic continuity is enabled by a Boundary-State Preservation Logic that extracts a Terminal Hidden State Vector (representing the mathematical context of a current chunk) and persists it in a Persistent State Registry; this vector is then programmatically injected as the Initial-State Seed for the subsequent data fragment to prevent phoneme truncation. Finally, the Reactive Stream Regulator enables network scalability by monitoring a Resource-Utilization Metric against a Critical Congestion Threshold; upon a threshold breach, the regulator transmits a Throttle-Command Signal (e.g., an X-Backpressure-Delay HTTP header) to the Universal Communication Gateway to programmatically force the client interface to increase its Transmission Interval. These protocols represent specific technical implementations of machine logic that transform the physical state of memory and network hardware, and are intended to support claims to both the structural modules and the underlying methodology.

As used herein, various data structures, object attributes, and software variables are described using specific naming conventions (e.g., camelCase, snake_case, or PascalCase). It should be understood by those skilled in the art that such casing and naming conventions are purely exemplary and for illustrative purposes only. The specific capitalization, spacing, or formatting of a data field (e.g., ‘contractDraft’, ‘ContractDraft’, or ‘contract_draft’) does not alter its functional scope or technical identity within the system architecture.

A key benefit of the present system is that it is platform-agnostic. The core innovations operate independently of any specific Contract management platform (e.g., Dotloop, SkySlope, Brokermint), Speech-to-text service (e.g., OpenAI Whisper, Google Speech, Amazon Transcribe), or AI/language model provider. Further, the prior art does not have domain-specific field extraction or transaction-type-aware questioning, and lacks the semantic mapping and compound statement parsing disclosed to provide the conversational flow. Further, the iterative error recovery and graceful degradation by programmatically pruning invalid fields from a rejected payload and resubmitting valid data is a previously unseen innovation.

The disclosed Dynamic Transaction-Type Aware Questioning determines which question to ask next based on transaction state; only asks for BUYERS in purchase offers, only SELLERS in listings. The Voice-toStructured-Data Semantic Mapping facilitates the extraction of address, price, names, dates from compound natural language statements. The Relative Date Conversion enables the transformation of conversational verbage such as “close in three weeks” into calculated calendar dates (e.g., “02/18/2026”). The Shared Last Name Expansion enables the parsing of conversational language such as “John and Jane Smith” into the specific and necessary itemization for two complete participant records with expanded names. The Iterative Error Recovery offers the advance of automatically removing invalid fields from a payload of data being submitted to a third-party platform, and retries with valid data subset(s).

Prior art systems generally lack many of the features of the present disclosure, including but not limited to:
Domain-specific field extraction—namely semantic extraction engine with patterns for addresses, prices, names, and dates specific to real estate transactions.
Multi-field extraction from single utterance—namely the ability to parse “123 Main St, Dayton OH 45402 for John Smith at 500k” into 7+structured fields simultaneously.
Transaction-type branching—namely getNextContractQuestiono adapts questioning based on PURCHASE_OFFER vs LISTING_FOR_SALE vs other types.
Downstream platform orchestration—namely a multi-stage integration pattern with iterative error recovery.
State persistence across conversation—ContractDraft interface tracks collected data, pending confirmations, and questions asked.
Dynamic questionnaire based on transaction type—namely question selection logic that evaluates transaction context.
Downstream platform integration—namely multi-stage communication gateway integration pattern with error recovery.
Iterative error recovery—namely the removal of invalid fields and retry protocol on platform validation failures.

Prior art systems fail completely when any submitted field doesn't match the target platform's template configuration. Contract management platforms have varying templates across different accounts and configurations, making field compatibility unpredictable. The iterative error recovery algorithm parses structured error responses to identify specific invalid fields, removes only those fields from the payload, and retries the request. This preserves all valid data despite template variations—a behavior not taught or suggested by prior art which assumes uniform platform configurations.

Real estate professionals naturally say “close in three weeks” or “two week inspection period” rather than providing exact dates in platform-required formats. Prior art systems require explicit date input. The relative date conversion algorithm: Converts number words (“three”) to integers, Identifies time units (“weeks”, “days”, “months”), Calculates target date from current date, and Formats to platform-required format. The present semantic mapping from informal temporal expressions to exact dates is not taught by prior art.

In real estate, a purchase offer is written by the buyer's agent who knows buyer information but NOT seller information (which comes from the listing). Conversely, a listing is written by the seller's agent who knows seller information but NOT buyer information. The present dynamic questionnaire engine evaluates transaction type and adapts question sequencing:
For PURCHASE_OFFER/LEASE_OFFER: Only asks for buyers/tenants
For LISTING_FOR_SALE/LISTING_FOR_LEASE: Only asks for sellers/landlords

This transaction-context-aware questioning eliminates redundant prompts and reflects real-world real estate workflows—a domain-specific optimization not taught by general-purpose prior art systems.

The present disclosure is described with reference to specific exemplary embodiments for clarity, but the claims are not limited to any particular:
Contract management platform: In one embodiment, the system integrates with Dotloop. Alternative embodiments may integrate with SkySlope, Brokermint, DocuSign Rooms, or any platform with structured data APIs.
Speech-to-text service: In one embodiment, the system uses OpenAI Whisper. Alternative embodiments may use Google Cloud Speech-to-Text, Amazon Transcribe, AssemblyAI, or any speech recognition service.
AI/language model provider: The semantic extraction algorithms operate independently of any specific AI provider.

The core innovations disclosed herein are platform-agnostic. For purposes of this description, certain aspects, advantages, and novel features of the embodiments of this disclosure are described herein. The disclosed methods, apparatus, and systems are not limiting in any way. Instead, the present disclosure is directed toward all novel features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved. The scope of this disclosure includes any features disclosed herein combined with any other features disclosed herein, unless physically impossible.

Although the operations of some of the disclosed embodiments are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed components can be used in conjunction with other components.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. Such descriptions are intended to indicate that a selection among many alternatives can be made, and such selections need not be better, smaller, or otherwise preferable to other selections.

In the description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing dimensions, forces, masses, frequencies, material quantities, angles, pressures, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing embodiments from discussed prior art, the embodiment numbers are not approximates unless the word “about” is recited. Furthermore, not all alternatives recited herein are equivalents.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

The inventive features include all novel and non-obvious features disclosed herein both alone and in novel and non-obvious combinations with other elements. As used herein, the phrase “and/or” means “and”, “or” and both “and” and “or”. As used herein, the singular forms “a,” “an,” and “the” refer to one or more than one, unless the context clearly dictates otherwise. As used herein, the term “includes” means “comprises.” The preferred embodiments of the invention accomplish the stated objectives by new and novel arrangements of elements and configurations, materials, and methods that are configured in unique and novel ways and which demonstrate previously unavailable but preferred and desirable capabilities. The description set forth below in connection with the drawings is intended merely as a description of the presently preferred embodiments of the invention, and is not intended to represent the only form in which the present invention may be constructed or utilized. The description sets forth the designs, materials, functions, means, and methods of implementing the invention in connection with the illustrated embodiments. It is to be understood, however, that the same or equivalent functions, features, and material properties may be accomplished by different embodiments that are also intended to be encompassed within the spirit and scope of the invention. The present disclosure is described with reference to the accompanying drawings with preferred embodiments illustrated and described. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout the disclosure and the drawings. In the figures, the thickness of certain lines, layers, components, elements or features may be exaggerated for clarity. All publications, patent applications, patents, and other references mentioned herein are incorporated herein by reference in their entireties.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The architecture of this invention—specifically the ability to transform informal, compound speech into structured data while dynamically adapting to context—is highly transferable to several high-stakes, form-intensive industries. This technology may be applied to:

### 1. Medical and Healthcare Documentation

Clinicians often spend significant time entering patient data into Electronic Health Record (EHR) systems. This invention could revolutionize bedside or post-visit charting. Clinical Intake: A doctor could state, “Patient presents with a 102 fever, sharp abdominal pain, and has been symptomatic for three days,” and the system would simultaneously populate the Vitals (Temperature), Symptoms, and Duration fields. Contextual Branching: If a doctor mentions “pregnancy,” the dynamic questionnaire would immediately pivot to prenatal-specific questions (e.g., due date, trimester) while suppressing irrelevant male-specific health fields. Relative Dates: Transforming “symptoms started last Tuesday” into a specific timestamp for the medical record.

### 2. Legal and Insurance Claims Processing

Both legal intake and insurance adjusting rely on converting a narrative (what happened) into a structured claim or case file. Insurance Adjusting: An adjuster on-site at a vehicle accident could describe the scene: “2022 Sedan with front-end damage, shattered windshield, occurring at the intersection of 5th and Main.” The system would extract the vehicle year/type, damage locations, and geographic coordinates. Iterative Error Recovery: If an insurance carrier's legacy backend rejects a “Claim Type” field, the system could prune that specific error and still save the critical damage and location data, preventing the adjuster from losing their field notes.

### 3. Logistics and Bill of Lading Management

Freight and shipping industries still rely heavily on complex forms to move goods across borders. Inventory Ingestion: A warehouse manager could call out shipments: “Twelve pallets of Grade-A timber from Vancouver arriving on the 14th via Northern Rail.” Normalization: Mapping “Grade-A timber” to specific standardized SKU codes and “Northern Rail” to the corresponding carrier ID in a logistics platform like SAP or Oracle.

### 4. Field Service and Industrial Inspections

Technicians working on complex machinery (wind turbines, aircraft, or oil rigs) often cannot use their hands to type on a tablet while performing an inspection. Hands-Free Compliance: A technician can describe a fault: *“Hydraulic leak detected on the secondary actuator, pressure reading at 40 PSI.” State-Machine Logic: If the system detects a “Critical” fault level, the questionnaire can dynamically inject emergency safety protocol questions that must be confirmed before the inspection can continue.

### 5. Financial Services and Loan Origination

Similar to real estate, the mortgage and private banking sectors require the collection of vast amounts of sensitive participant data. Bifurcated Name-Origin Logic: When a loan officer discusses a joint application for “Robert and Linda Thompson,” the system can use the shared last name expansion to create two distinct borrower entities, then move into a confirmation workflow to ensure the spelling matches their legal IDs. Proactive Intent Scoring: In a banking context, the system could monitor a conversation between a client and a wealth manager to determine when the discussion has moved from “general inquiry” to “intent to trade,” proactively staging the trade order for the manager's approval.

### 6. Human Resources and Recruitment

High-volume recruiting requires moving from an interview narrative to a structured candidate scorecard. Interview Summarization: After an interview, a recruiter could state, “Candidate has five years of Python experience, expects 120 k, and can start in two weeks.” The system would extract the Skillset (Python), Tenure (5 years), Salary Expectation (120,000), and Availability Date.

What is claimed is:

1. A computer-implemented method for transforming unstructured natural language into structured real estate transaction data, the method comprising:
receiving, via a voice capture interface, a digitized data stream corresponding to a compound natural language utterance containing a plurality of discrete real estate data points;
executing, via a conversational contract engine, a multi-slot semantic extraction on the digitized data stream to decompose the compound natural language utterance into a plurality of structured data fields;
maintaining a domain-specific contract-draft state object configured to track a current resolution status for a plurality of transaction variables;
operating a dynamic questionnaire engine as a state-machine-driven controller to determine a next logical inquiry based on a hierarchical priority evaluation of the contract-draft state object;
initiating an automated state-interrupt signal to programmatically divert the dynamic questionnaire engine from a data collection phase to a data verification phase upon the detection of an auto-extracted data field requiring user confirmation;
mapping the validated transaction variables from the contract-draft state object to a standardized contract template; and
orchestrating a multi-stage synchronization of the validated transaction variables with a third-party contract management platform via an iterative error recovery sequence, wherein the sequence programmatically prunes non-compliant fields from a rejected data payload and resubmits valid data until a successful platform response is received.
